(19) United States
(12) Patent Application Publication
(10) Pub. No.: US 2002/0055868 A1
(43) Pub. Date: May 9, 2002

(54) System and method for providing a task-centric online environment

(76) Inventors: Angela G. Dusevic, Houston, TX (US); Michele A. Wood, Houston, TX (US)

Correspondence Address: Jeffrey C. Hood, Conley, Rose, & Tayon, P.C., P.O. Box 398, Austin, TX, 78767, US

(21) Appl. No.: 09/862,637

(22) Filed: May 22, 2001

Related U.S. Application Data
(60) Provisional application No. 60/206,855, filed on May 24, 2000.

(51) Int. Cl. G06F 17/60

(52) U.S. Cl. 705/9

(57) ABSTRACT

A system and method for presenting a task-centric online environment is provided. In one embodiment, the environment may be implemented as an Internet website. The end user can navigate according to a task-centric model, finding relevant information with respect to a problem, as well as proposed product solutions and other information that helps in solving a particular problem. A user may navigate through a series of interfaces, with each interface being at a more detailed level of a possible solution for a particular problem or class of problems or at a more detailed level of performing a particular task or class of task. One embodiment may provide a “Personal Binder” that enables the user to store links to information located in the environment. One embodiment of the environment may be targeted at the upstream exploration and production area of the oil and gas industry.

### PRIORITY DATA

This application claims benefit of priority of provisional application Ser. No. 60/206,855 titled “System And Method For Providing A Workflow-Oriented Online Environment” filed May 24, 2000 whose inventors are Angie G. Dusevic and Michele A. Wood (Dkt. No. 5460-00400).

### FIELD OF THE INVENTION

The present invention generally relates to computer software programs and network technologies, such as Internet web sites. More particularly, the present invention relates to providing a task-centric online environment to provide knowledge base content to end users, particularly in the upstream exploration and production areas of the oil and gas industry.

### DESCRIPTION OF THE RELATED ART

Organizational-based online environments typically present to a customer a rigid, structured interface representing a hierarchical view of a corporation according to the organization of a corporation. Prior art organizational-based online environments may be presented as websites hosted by the corporation. The corporation, behind the scenes, creates content to be filtered out through the interface. Organizational-based online environments typically present a standard interface with areas such as About Us, Products, News, Solutions (How-To's), FAQs, Customer Support, Professional Services, Sales and Training. Thus, the organizational-based online environments are typically service-related and/or product-related, hierarchical, and not outcome- or task-driven. In other words, these environments are typically geared towards marketing products and/or services rather than enabling users to easily find solutions to problems.

These environments typically require the customer to know what products and/or services offered by the corporation are appropriate to solve a particular problem before using the site. For example, the site may include multiple How-To sections, with one or more How-To section for each product or service offered by the corporation. The user has to know what the products and services do to know which How-To section(s) may include information on solving a particular problem. Thus, the organizational-based online environments may require the user to drill down layer after layer, to read detailed information on one or more products or services, and/or to search the website to obtain an answer to a particular problem.

Organizational-based online environments may include one or more tools that may be used to provide information to end users. Workflow technology implements specific business rules to govern the work path, work users and a work timeline to control a very precise process flow. Both instructions and rules are predetermined and stored in a repository. Administrators create rules using specific tools for the workflow. Workflow applications look to maximize productivity by minimizing process deviations in a well-defined and well-understood process. They accomplish this by providing pathways for very repeatable processes. FAQs (Frequently Asked Questions) are knowledge bases that are generally short and organized in a table of contents fashion. FAQs are meant to compliment the user's manual for a particular product. FAQs are generally a reactionary document on a specific product or subject to assist users to resolve issues and pitfalls that are common to a user base. Help files are knowledge bases for finding specific questions about specific functionality of a product. They generally represent information found in the product manual. They generally do not assist in planning strategies to solve broad issues. In addition, help files are generally organized in an index and table of contents format. This means that solutions are only found in one location in the document. Rule-based Artificial Intelligence (AI) search engines typically organize large amounts of non-homogenous documents in many different knowledge bases and apply a hierarchy to the knowledge around complex rules. The rules allow the system to automatically tag each piece of content and place it in appropriate locations in a knowledge hierarchy. This allows new content to be tagged and categorized very quickly.

Organizational-based online environments may be particularly limiting in the upstream exploration and production areas of the oil and gas industry. The upstream exploration and production areas of the oil and gas industry are not manufacturing type industries where the same tasks may be repeated in the same way multiple times. In oil and gas interpretation, every oil and gas play may be different and unique. An oil and gas play may be defined as any potential or existing oil and gas reservoir. Very rarely will a series of tasks be performed over and over again in the same way. One time a user may use one combination of tasks, and the next time a different combination. Also, interpretation for a particular oil and gas play may take a year or longer, so some tools (e.g. products and/or services provided by vendor corporations, also referred to as vendors) are not typically used on a frequent basis.

Therefore, a system and method is desired which provides an improved online environment.

### SUMMARY OF THE INVENTION

One embodiment of the present invention comprises an improved system and method for providing a task-centric online environment. In one embodiment, the online environment may be implemented as a network environment, such as an Internet website. This task-centric online environment allows users to navigate or browse through the online environment in a task-centric manner. Thus, instead of presenting the user with a hierarchical view of a corporation according to the organization of the corporation, one embodiment operates to provide a task-centric view of a task or problem that the user desires to solve. Thus, the user can navigate according to a task-based model, easily finding more relevant information with respect to the user's problem, as well as proposed product solutions and other information that helps the user in solving the particular problem. For example, the user may more easily find known problems and solutions, troubleshooting guides, product usage “how to's”, online product integration training and tutorials, knowledge based search and online error reporting. Thus, embodiments of the present invention may provide a high value online environment that interactively addresses urgent technical, scientific and business questions for the user.

Embodiments of the task-centric online environment may be targeted at performing tasks and solving problems for users in any industry, business or enterprise. For example, some embodiments of the task-centric online environment may be targeted at performing tasks and solving problems for users in the oil and gas industry. Some embodiments may be targeted at performing tasks and solving problems for users in a particular area of an industry such as the upstream exploration and production areas of the oil and gas industry. Some embodiments may be targeted at performing tasks in a particular discipline within an industry or across industries. For example, one embodiment may be targeted at the geologist and geophysicist discipline of the upstream exploration and production areas of the oil and gas industry.

In the online environment, a user may navigate through a series of interfaces based upon user selection, with each interface being at a more detailed level of a possible solution for a particular problem or class of problems or at a more detailed level of performing a particular task or class of task. Embodiments may present the levels to the user in one or more displays, for example in “windows” on a computer monitor. In one embodiment, the online environment is a web site, and the levels are presented to the user as web pages.

In one embodiment, a playbook hierarchy may be used in modeling the task-centric online environment. In one embodiment, the task-centric online environment may display a “play” by funneling down from a task, to a subtask, then to a task detail, and finally to content. For the purposes of this document, a “play” may be defined as a strategy used to solve a particular problem or perform a particular task (from top to bottom) in the task-centric online environment. A playbook hierarchy (i.e., the relationship between work areas/tasks, tasks/subtasks, subtasks/task details, and task details/content) may have been previously defined to facilitate the display. Extensive, macro-level work processes may be referred to as high-level tasks or macro tasks. Specific, detailed tasks may be referred to as individual tasks. A macro tasks page may be used to navigate a hierarchy of high-level tasks in a particular work area. An individual tasks page may be used to choose among a plurality of individual task pages, which may then be used to navigate a hierarchy of an individual task.

In one embodiment, the task-centric online environment may provide a portion of the site as a “personal binder” that enables access to information that is customized by, and targeted to each user. This includes communication with customer support bookmarks (links to content created by the user), subscriptions to content of interest to the user such as news, discussion forums, events, and contacts, etc.

### BRIEF DESCRIPTION OF THE DRAWINGS

A better understanding of the present invention can be obtained when the following detailed description of various embodiments is considered in conjunction with the following drawings, in which:

FIG. 1 illustrates a network system according to one embodiment;

FIG. 2 illustrates a task-centric method for providing content for access by users according to one embodiment;

FIG. 3 illustrates a hierarchical relationship of web pages and content in a task-centric online environment according to one embodiment;

FIG. 4 is a flowchart illustrating a method of using the individual tasks pages and/or the macro tasks web pages of the task-centric online environment according to one embodiment;

FIG. 5 is a flowchart illustrating a method of using the task-centric online environment to locate content for use in task resolution and problem solving according to one embodiment;

FIG. 6 illustrates an exemplary home page of a task-centric online environment according to one embodiment;

FIG. 7 illustrates an exemplary web page with links to a plurality of individual task web pages;

FIG. 8 illustrates an exemplary individual task web page according to one embodiment;

FIG. 9 illustrates an exemplary individual task web page with a subtask of the individual task selected to display task details for the subtask according to one embodiment;

FIG. 10 illustrates an exemplary content page according to one embodiment;

FIG. 11 illustrates an exemplary individual task web page with another subtask of the individual task selected to display task details for the subtask according to one embodiment;

FIG. 12 illustrates another exemplary content according to one embodiment;

FIG. 13 illustrates an exemplary macro tasks web page according to one embodiment;

FIG. 14 illustrates an exemplary macro tasks web page with a high-level macro task and subtask selected to display task details for the subtask according to one embodiment;

FIG. 15 illustrates another exemplary content page according to one embodiment;

FIG. 16 illustrates an exemplary layout of another page of content accessed from the page illustrated in FIG. 11 according to one embodiment;

FIG. 17 illustrates an exemplary personal binder personalization page according to one embodiment; and

FIG. 18 illustrates an exemplary personal binder links page according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF THE INVENTION

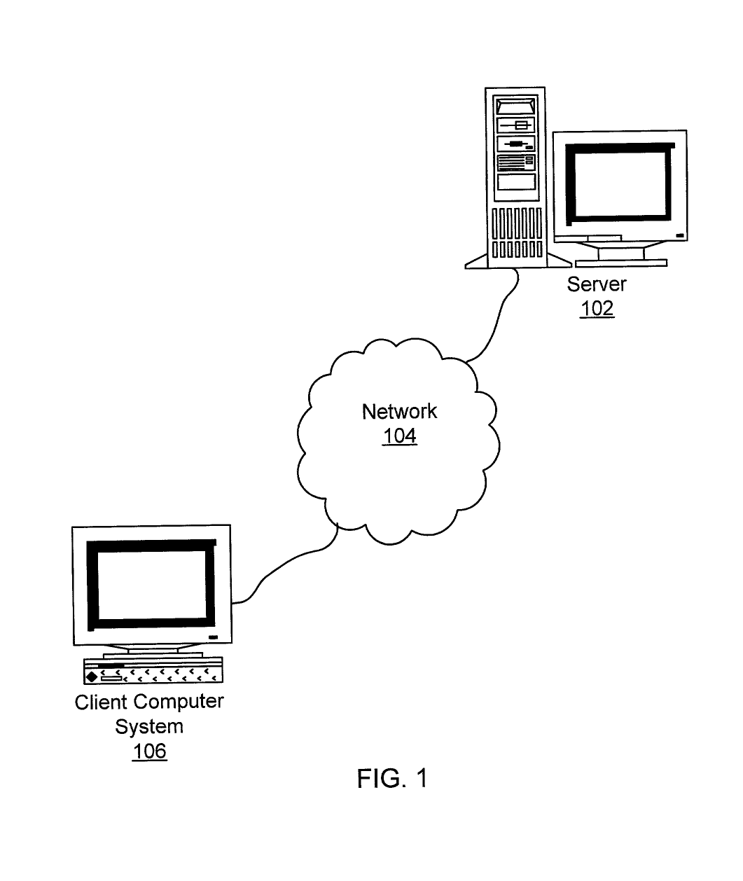

FIG. 1: Network System

FIG. 1 illustrates a simplified and exemplary network system according to one embodiment of the present invention. The embodiment illustrated in FIG. 1 includes one server 102 and one client system 106, which may be connected to a network 104 such as the Internet. However, it is noted that the present invention may be utilized with respect to any number of servers 102 and client systems 106.

As shown in FIG. 1, in one embodiment, a provider who offers products, services and/or information over network 104, such as the Internet, may maintain the server 102. The products, services and/or information may be offered at a cost, or alternatively access to the products, services and/or information may be free. The products, services and/or information may be related to one or more fields of endeavor. In this document, “field of endeavor” may be used to refer to any of various fields, areas or disciplines including, but not limited to: the business field (e.g. banking, retail, law practice, etc.), industry (e.g. oil and gas, petrochemical, manufacturing, refining, shipping, transport, etc.), engineering discipline (e.g. chemical engineering, mechanical engineering, electrical engineering, etc.), non-profit organization, medical field, research field (e.g. medical, chemical, etc.), field of science (e.g. Biology, Geology, Physics, Geophysics, Chemistry, Aeronautics, Astrophysics, etc.), field of academics (e.g. Philosophy, Mathematics, Social Studies, History, etc.), field of sports or entertainment, or in general any field for which a knowledge base of related information may be used. The knowledge base may include information related to one or more products and/or services that are offered by the provider to end users. The products and/or services may be available to end users for a fee or alternatively may be offered to end users free of charge.

As shown, the server 102 may be connected to a network 104. Embodiments of the present invention may also be used with any of various types of networks including, but not limited to, local area networks (LANs), wide-area networks (WANs), intranets, and networks of networks, such as the Internet, which connects computers and networks of computers together, thereby providing the connectivity for enabling communication and information exchange. Thus, the network 104 may be any of various types of networks including the Internet, including wired and wireless networks, or combinations thereof.

Client system 106 may also be connected to the network 104. The client system 106 may be of various kinds of systems such as a computer system, a workstation, a terminal, a network appliance, an Internet appliance, a Personal Digital Assistant (PDA), WEB TV, telephone, two way pager, etc. The client system 106 may execute software which provides the user with a user interface to the task-centric online environment. For the purpose of this document, this software program may be referred to as “user interface software”. The user interface software may also allow the user of the client system 106 to browse and/or search the network 104, and also may allow the user to conduct transactions or commerce over the network 104. In one embodiment, the user interface software may implement a front-end application to the task-centric online environment. In one embodiment, the user interface software may implement a web browser.

In one embodiment, when the user of the client system 106 desires to access information or services, or purchase a product, from a provider over the network 104, the user interface software may be used to access the respective server, such as server 102. The user interface software may then be used to access one or more displays provided by the server 102 directly, or may access the displays through a link from a third party (e.g. a web site on the server 102 or on another server). The term “display” may include the notion of a page, screen, window, web page or other information presentation object that may be presented to an end user on a display device or mechanism coupled to a client system 106. Display devices may include, but are not limited to, CRTs, flat screens, LCDs, monitors, televisions, or other devices capable to textually and/or graphically display information provided by a computer system such as client system 106. The user of the client system 106 may also be referred to as a customer, a client or an end user.

Server 102

The server 102 may include various standard components such as one or more processors or central processing units, one or more memory media, and other standard components, e.g., a display device, input devices, a power supply, etc. The server 102 may also be implemented as two or more different computer systems.

A server may be defined as a computer or computer program that, when executed, provides services to other computer programs executing in the same or other computer systems. The computer system on which a server program is executing may also be referred to as a server, though it may contain a number of server and client programs. In the client/server model, a server is a program that awaits and fulfills requests from client programs in the same or other computer systems.

The server 102 may include a memory medium on which computer programs according to the present invention are stored. The term “memory medium” is intended to include various types of memory or storage, including an installation medium, e.g., a CD-ROM, or floppy disks, a computer system memory, e.g., a random access memory (RAM), such as DRAM, SRAM, EDO RAM, Rambus RAM, etc., or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the server 102 may take various forms, including a computer system, mainframe computer system, workstation, or other device. In general, the term “computer system” or “server” can be broadly defined to encompass any device having a processor that executes instructions from a memory medium.

The memory medium may store software and other information for enabling a task-centric online environment according to the methods or flowcharts described below. The software may be implemented in any of various ways, including procedure-based techniques, component-based techniques, and/or object-oriented techniques, among others. For example, the software program may be implemented using ActiveX controls, J2EE, XML, XSL, C++ objects, Java objects, Microsoft Foundation Classes (MFC), or other technologies or methodologies, as desired. The other information may include one or more files which comprise the content information of the task-centric online environment and which may be referred to as the knowledge base of the task-centric online environment. The other information may also include markup language (e.g. HTML, XML, XSL) documents that may be provided by the server system to the client systems for presenting an interface to the content information of the task-centric online environment. A CPU, such as the host CPU, executing code and data from a memory medium comprises a means for implementing a task-centric online environment according to the methods, flowcharts or screen shots described below.

In one embodiment, the task-centric online environment may an “in-house” implementation by an organization as an application on a server system or other computer system that is accessible by one or more end users using client systems coupled to the server system via an intranet or through other methods of coupling client systems to server systems (e.g. direct connect, point-to-point, etc). In this embodiment, access to the task-centric online environment from “outside” (e.g. the Internet) may be prohibited or restricted.

In one embodiment, the task-centric online environment may be implemented on the Internet as a web site or sites provided by one or more web servers. The web site or sites may be accessed by an end user through the user interface software (typically a web browser such as Microsoft Internet Explorer and Netscape Communicator). The web server may then “serve” one or more web pages of the web site to the client system 106. The web pages may be displayed on the client system by the user interface software (e.g. web browser) to provide a user interface to the task-centric online environment. The web site or sites may thus provide a mechanism by which end users may navigate the task-centric online environment to locate and display content from the knowledge base to the end user on the client system 106.

In one embodiment, the task-centric online environment may be accessed from a vendor application running in the field. In this embodiment, when in the field and running an application supplied by the vendor, if an end user is having a problem, the end user is able to invoke the task-centric online environment from within the application and thus may have access to the task-centric online environment in real-time without having to access it through user interface software external to the application.

In one embodiment, the task-centric online environment may be provided by an Application Service Provider (ASP), and may be accessed by a user of a client system 106 through the ASP. Thus, the ASP may provide access to the task-centric online environment to the end user. An ASP offers individuals or enterprises access over the Internet to applications and related services. ASPs may provide applications and services to small enterprises and individuals on a pay-per-use or license basis. Some corporations may provide their own ASP service in-house, moving applications off personal computers and putting them on a special kind of application server that may be designed to handle a thin client workstation.

In one embodiment, the task-centric online environment may be accessed on the network through a network connection, dialup connection, wireless connection or other connection method. In one embodiment, the task-centric online environment may be stored on a hard disk, CD ROM or other media accessible from the client system 106. For example, the task-centric online environment may be stored on a CD. The CD may be inserted into a CD ROM drive on the client system 106. The user may then execute user interface software (stored on the client system or alternatively on the CD) to access the task-centric online environment. Various embodiments may further include receiving, sending or storing instructions and/or data implemented in accordance with the foregoing description upon a carrier medium. Generally speaking, a carrier medium may include storage media or memory media such as magnetic or optical media, e.g., disk or CDROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless connection.

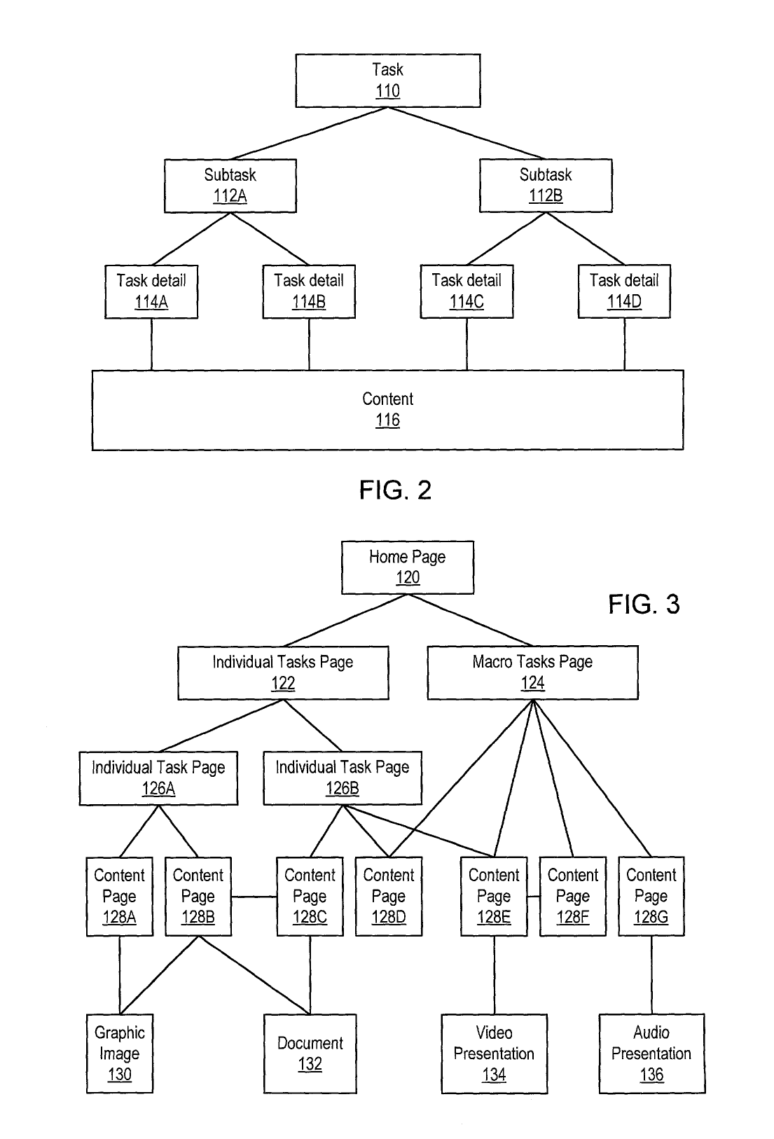

FIG. 2—Providing Content to End Users in a Task-centric Online Environment

In one embodiment, the task-centric online environment may present content in a category-based hierarchal taxonomy as illustrated in FIG. 2. A task 110 may include one or more subtasks 112. Subtasks may be topics or outcomes within the task. Each subtask 112 may include one or more task details 114. Each task detail 114 may be associated with one or more content 116 documents. The task-centric organization may enable the end user to easily locate the key pieces of information needed to quickly and accurately accomplish a task. Rather than having to know the organization of a company and its products or services, the end user may search for content 116 specific to the task that he or she is trying to accomplish.

There may be a plurality of tasks 110. In one embodiment, tasks 110 may be grouped into yet higher categories. For example, an industry (e.g. oil and gas) may include several areas (e.g. upstream exploration and production in the oil and gas industry). These areas of the industry may again be subdivided into disciplines. For example, exploration and production may be subdivided into several disciplines including geology and geophysics, drilling, production disciplines (e.g. production engineering and reservoir engineering), business management and information management. Geology and geophysics is a discipline related to the interpretation of structures such as surfaces, horizons and faults in the earth's subsurface through the use of 2D/3D seismic data and well data. Activities in geology and geophysics may include, but are not limited to velocity modeling, model refinement and validation, depth conversion and depth imaging; seismic poststack attribute analysis; poststack processing; 3D and 2D seismic processing; multidisciplinary reservoir characterization that enable geoscientists and engineers to automatically find, visualize and study relationships among various seismic and reservoir attributes in familiar map and cross-section views. The drilling discipline is involved in well planning and operations activities from prospect evaluation through detailed planning, operations monitoring and ultimately post-well analysis.

The production (Reservoir and Production Engineering) disciplines include petroleum, reservoir, drilling, production and economic engineers. They focus on optimizing production and forecast production performance, while driving better, faster decision-making. Activities in these disciplines may include, but are not limited to: reservoir simulation for constructing accurate and consistent reservoir models; well log analysis; assessment of 3D reservoir characteristics to accurately define hidden reserves and identify potential drilling targets; mapping and modeling; production data management; and organizing, managing and evaluating critical economic and production data.

The business management discipline may include multiple disciplines (e.g. geologists, geophysicists, and engineers) involved in technical and business analysis for energy companies holistically, incorporating risk and uncertainty at every link in the exploration and production value chain. Historically, acquisition and analysis of technical data drives business decisions. The more holistic approach provided by the business management discipline reverses the process. Capital can be allocated only when it is clear how additional technical information will impact the corporate bottom line.

The business management discipline may also include multiple disciplines (geologists, geophysicists, engineers) involved in activities around risk-based asset evaluation and enterprise portfolio management and/or economics and reserve management.

The information management discipline may include several activities including, but not limited to: data management (well, seismic, culture, interpretation) for integrated asset teams; regional or enterprise data management systems; and workflow and project documentation. The information management discipline may be applied to all upstream exploration and production disciplines such as geology, geophysics, and engineering.

These disciplines may each include one or more work areas. For example, geology and geophysics may have a structural interpretation work area, and drilling may have well design, operation, and completion work areas.

Extensive, macro-level work processes may be referred to as high-level tasks or macro tasks. Specific, detailed tasks may be referred to as individual tasks. Tasks 110 may be individual tasks in a discipline or work area and/or as high-level tasks in a discipline or work area. Thus, the task-centric online environment may provide an interface that allows end users to choose among one or more areas of an industry, among one or more disciplines of an area, and/or among one or more work areas of a discipline. The examples in this document focus on the geology and geophysics discipline of the exploration and production areas of the oil and gas industry, and upon the structural interpretation work area of geology and geophysics. However, the task-centric online environment as described herein may be used to supply content to end users in a task-centric manner for other industries, areas of industries, disciplines within industries, and work areas within disciplines.

In general, categories (e.g. tasks 110, subtasks 112, and task details 114) are associated in a hierarchal manner with categories containing zero, one or more children categories and zero, one or more content documents. In addition, categories may be associated with more that one parent category and documents (content) may be associated with more than one category. Possible interactions between categories and documents include, but are not limited to:

Categories can be associated with more than one parent category.

A document can be associated with more that one category.

Documents can be associated with more than one parent document.

The flexibility of this taxonomy allows documents and categories to be linked together (associated) in an infinite number of ways to ultimately provide the user with many paths or “plays” to get to the same piece of information. In this context, for the purposes of this document, a “play” may be defined as a strategy used to solve a particular problem or perform a particular task (from top to bottom) in the task-centric online environment.

In one embodiment, the taxonomy that organizes all of the “plays” and the associated hierarchies may be organized and administered manually by administrators of the task-centric online environment. Categories may be created as children of other categories. If a category can be displayed in more than one area, the administrator may copy the hierarchy branch from one category to another. Documents may be created inside of categories. However, once a document is created, it may be associated with other categories or to other documents. Thus, the user may find the document in more than one related work path or “play” which represent a category structure in the knowledge repository. In one embodiment, in addition to assigning category taxonomy, the administrator may have the ability to secure each piece of content and category to be viewable or not viewable by any single or group of end users. Unlike AI knowledge base systems, content may be categorized and organized by the administrators, and thus the task-centric online environment may provide focused solutions to problems an end user is attempting to solve.

The task-centric online environment may provide to end users a “playbook” organization of non-homogeneous solutions that are collected and stored in the knowledge base. The task-centric online environment may use a task knowledge base that will tie in content 116 including solution documents from support, online reference manuals, FAQs, white papers, recommended micro-tasks, and other sources. These documents may be tied together in a logical interpretation methodology that leverages as much preexisting material as possible. The content 116 may include information that may be presented to end users in one or more of various forms including textually, graphically (image data), as video, and as sound.

One embodiment of the task-centric online environment organizes a knowledge base around solutions to problems in the exploration and production areas of the oil and gas industry. In one embodiment, the task-centric online environment may include one or more sections each concentrating upon a particular discipline. For example, within exploration and production, these disciplines may include, but are not limited to, geology and geophysics, drilling, production engineering, reservoir engineering, business management and information management. In one embodiment, the sections within the task-centric online environment may include descriptions of plays and strategies (or set of strategies) used by an individual professional (e.g. geologist or geophysicist) or asset team (e.g. structural interpretation) primarily around the use of exploration and production technology (products and services provided by the site vendor) and the tasks to be accomplished. An example is a play or strategy to accomplish the creation of a basemap or to do velocity modeling. The plays or strategies may at times vary dependent on the geologic nature of a particular oil and gas play. An oil and gas play is a term commonly used to describe a potential or existing oil and gas reservoir.

In one embodiment, the “plays” and associated solutions may be displayed to the end user in hierarchal fashion. In one embodiment, the end user is able to drill down into specific areas using a view (e.g. web page) that shows three levels of hierarchy and that may dynamically update, for example when an end user selects a different subtask 112. In one embodiment, four or more levels of the hierarchy may be displayed for and navigated by the end user while following a play. This “drill down” hierarchy represents the category taxonomy that holds the documents.

The task-centric online environment provides solutions via a broad, task based solution path, unlike other knowledge bases that are organized around specific products and how to use that specific product to solve a specific problem. The task-centric online environment focuses on the end users' world and reflects their semantics. For example, in the exploration and production areas of the oil and gas industry, if an end user has a question involving creating a synthetic (i.e. tying seismic data to wells), the site provider may have a particular tool (e.g. software application) configured for use in this area. Preferably, the end user does have to know that there is a tool of the particular name offered by the provider. Preferably, the end user is able to access information directly about creating a synthetic. One embodiment of the task-centric online environment allows the end user to start from the level of a specific task (e.g. “create a synthetic”) and to “drill down” to specific content 116 that is available to assist the end user in accomplishing the task. As used herein, a specific task is a “low-level” task (as opposed to a high-level or “macro” task) that is performed to produce a specific result (e.g. a synthetic is the product of the “create a synthetic” task). In one embodiment, only at the content level is information on specific products and/or services presented to the end user, and then as parts of solutions to particular plays being researched. Prior art online environments, particularly in the exploration and production areas of the oil and gas industry, require the end user to start at the product or service level and to search through information on those products for information on performing a specific task. Thus, the end user must have knowledge of the corporation and its products and/or services to find information on performing specific tasks.

In some disciplines such as oil and gas interpretation, very rarely will the same task be done over and over again in the same way. For example, in oil and gas interpretation, every oil and gas play may be different and unique. One time a user may use one combination of tasks, and the next time a different combination. Not a workflow because rarely are the same steps repeated in the same way to solve a problem. Not a manufacturing type industry where the same tasks may be repeated in the same way multiple times.

The task-centric online environment's is based on the lack of a precise process flow. The task-centric online environment may focus on problems for no well-defined and not-well-understood processes. No rules, timelines or users are maintained in the task-centric online environment. The content in the task-centric online environment's knowledge base may be configured to provide solutions to solve many process deviations. By providing end users possible solution deviations, they are given the power to decide the best way to maximize investments in products and services offered by the site vendor to solve problems.

The task-centric online environment may accommodate growth for future regional or topical “plays”. For example, in the exploration and production areas of the oil and gas industry, some embodiments may be directed to specific geologic plays (e.g. deep water salt, North Sea, Austin Chalk, Permian basin). For example, there may be one or more data reconnaissance tasks and/or subtasks for Austin Chalk plays, North Sea plays, Gulf of Mexico plays, etc.

FIG. 3—Web Pages and Content in a Task-centric Online Environment

FIG. 3 illustrates an exemplary hierarchy of pages or displays for accessing content in a task-centric online environment according to one embodiment. In one embodiment, the displays may be web pages. A home page 120 may include one or more links to access pages in the next level of web pages. For the purpose of this document, a link may be defined as a selectable connection from one word, picture, or information item to another. On a computer display, a link may be represented by an item such as an icon, picture, text string (e.g. word, phrase, or section of text), Uniform Resource Identifier (URI), Uniform Resource Locater (URL), network address such as an IP address, or other item. In a multimedia environment such as the World Wide Web, such items may include sound and motion video sequences. The most common form of link is the highlighted word or picture that can be selected by the user (with a mouse or in some other fashion), resulting in the immediate delivery and view of another object such as a file, web page, or another location on the page that includes the highlighted item. The highlighted item may be referred to as an anchor. The anchor reference and the object referred to (e.g. file) constitute a hypertext link.

These pages may include one or more individual tasks pages 122. An individual tasks page 122 may include one or more links to access individual task pages 126. Each of these links may be represent a particular individual task 110 of the discipline (e.g. geology and geophysics). Selecting one of these links may cause the display of the individual task page 126 for the particular individual task 110 represented by the link. In one embodiment, an individual task page 126 may display three levels of the hierarchy as illustrated in FIG. 2. The individual task page 126 may include an item that specifies the particular individual task 110 represented in this individual task page 126. The individual task page 126 may also include one or more user-selectable items each representing one of the subtasks 112 for this individual task 110. When an item representing one of the subtasks 112 is selected, one or more task details 114 for the particular subtask 112 may be displayed. The displayed task details 114 may include user-selectable links to one or more content pages 128. A content page 128 may include one or more user-selectable links to other content pages 128 and also may include thumbnails or icons that display other, possibly more detailed content items such as graphic images 130, documents 132 (e.g. PDF user manuals), video presentations 134, and audio presentations 136.

In one embodiment, an individual task page 126 may include a plurality of user-selectable items each representing an individual task 110. When one of the items is selected, subtasks 112 of the individual task 110 represented by the item may be displayed in the individual task page. An individual task page 126 that includes a plurality of individual task selector items may be useful, for example, to present an individual task 110 that may be performed using two or more different applications, or for presenting a group of related tasks. For example, an individual task page 126 may be represented on the individual tasks page 122 by an item that includes an indication, such as a text string or a graphic, that this is a “Create Project” item. The individual task page may include a plurality of items representing individual tasks such as “Create project in Application A”, “Create project in Application B”, etc.

A home page 120 may also include one or more links for accessing one or more macro tasks pages 124. A macro tasks page 124 may present extensive, macro-level work processes, which may also be referred to as high-level tasks or macro tasks. A macro tasks page may be associated with a work area. For example, the structural interpretation work area of the geology and geophysics discipline of the exploration and production areas of the oil and gas industry may be associated with a macro tasks page 124. Thus, the macro tasks page 124 may present an interface to one or more high-level tasks 110 in the structural interpretation work area.

A macro tasks page 124 may display three levels of the hierarchy as illustrated in FIG. 2. The macro tasks page 124 may display one or more user-selectable items each representing a particular high-level task 110. When an item representing one of the high-level tasks 110 is selected, one or more user-selectable items each representing one of the subtasks 112 for the currently selected (and thus active) high-level task 110 may be displayed. When an item representing one of the subtasks 112 is selected, one or more task details 114 for the particular subtask 112 may be displayed. The displayed task details 114 may include one or more user-selectable links to one or more content pages 128. A single content page 128 may be accessed from one or more macro tasks pages 124 and/or from one or more detailed item pages 126.

For example, one embodiment of the task-centric online environment may be directed towards geologic and geophysical tasks in the oil and gas industry. A hierarchy of web pages similar to that illustrated in FIG. 3 may be used to support a non-linear approach to the geologist and geophysicist interpretation workflow. In this embodiment, the hierarchy of web pages may implement a task-centric online environment (e.g. web site) that recognizes and supports the macro and micro level steps necessary to perform structural interpretation using the technology (e.g. products or services) provided by the site vendor. The task-centric online environment may provide assistance in the integration steps (e.g. Time-Depth conversions) and/or specific individual geologic and geophysical tasks (e.g. Mistie corrections) necessary when interpreting structure using the technology provided by the site vendor. Structural interpretation as related to geology and geophysics is the interpretation of geologic and/or geophysical data to understand the current state of the project area with regard to any deformation that may or may not have occurred since deposition. Typical products of this type of interpretation include horizon interpretation, structure maps, fault interpretation, fault plane maps, etc.

Individual Tasks in the Geology and Geophysics area of the Oil and Gas Industry

In one embodiment directed towards the geologic and geophysical area of the oil and gas industry, the task-centric online environment may include an individual tasks page 122 that may include a plurality of user-selectable items representing individual tasks 110. These items may when selected display an individual task page 126 for the particular individual task 110. These individual tasks 110 directed towards the geologic and geophysical area of the oil and gas industry may include, but are not limited to:

Project Creation and Data Management—The creation and filling of a project database (Application A) for the purpose of using the data and information contained in it for integrated interpretation, prospect generation, evaluation and review

Making Displays

Seismic Data Enhancement—Editing seismic data. Examples: smoothing, filtering.

Seismic Reconnaissance—Review quantity and quality of seismic data.

Seismic-Well Correlation—Create and edit Synthetics to calibrate seismic data with well data Time-Depth Conversion:—Moving information (seismic data, horizons, maps, etc.) from the time domain to the depth domain using a velocity function or field.

Geologic Reconnaissance—A process phase that projects go through in which log, core, well, outcrop, geochemical and/or other types of geologic information is gathered, quality checked, and analyzed in order to create an understanding of the geologic model.

Seismic Attribute Extraction—Calculating seismic data components based on specific algorithms to create either new attribute volumes, sections or attribute horizons Examples of seismic attributes include phase, reflection strength, amplitude, and energy half time.

Petrophysical Analysis—Log analysis, complex reservoir analysis (Example: lithology, fluids); Well Correlation and Cross Section: Correlation of Geologic surfaces/faults (depth); creation of structural or stratigraphic cross-sections.

Correlate/Extrapolate Well-Seismic Attributes—Determining relationships between seismic attributes and rock properties measured or interpreted from logs using techniques such as crossplots and histograms. Then, if appropriate, extrapolating through seismic data.

Well Correlation and Cross Section

Seismic Structure Interpretation—Interpreting seismic horizons (surfaces) and faults in the time domain.

Time-Depth Conversion

Well Path Planning—Defining proposed well path (deviated, straight hole, horizontal) including the designation of target location, size and orientation.

Geologic Mapping—Creation of Structure maps, isopach/isochron maps, net pay maps, etc.

The Project Creation and Data Management individual task page 126 may, when displayed, include one or more user-selectable items representing individual tasks 110 including, but not limited to:

Application A Project Creation

Application S Project Creation

Application A Data Loading

Seismic Data Loading

Import/Export

Well Data Management

Seismic Project and Data Management

Project Backup and Restore

Selecting the Application A Project Creation task 110 may display subtasks 112 that may include, but are not limited to:

Creating an Application A Project

Project Cartographic Reference System

Measurement Systems

Application A Project Size

Interpreters

Project Updates

Selecting the Application S Project Creation task 110 may display subtasks 112 that may include, but are not limited to:

3D Seismic Projects

2D Seismic Projects

Merged Projects

Seismic Project Delete

Seismic Project Update

Selecting the Application A Data Loading task 110 may display subtasks 112 that may include, but are not limited to:

Loading Well Locations

Loading Directional Well Data

Loading Curve Data

Loading Well Picks and Paleo Data

Loading Well Faults

Loading Lease Data

Loading Production Data and Image Files

Project Data Transfer

Selecting the Seismic Data Loading task 110 may display subtasks 112 that may include, but are not limited to:

3D Seismic Navigation Data

3D Seismic Trace Data

2D Seismic Navigation Data

2D Seismic Trace Data

Selecting the Import/Export task 110 may display subtasks 112 that may include, but are not limited to:

Application A Project Data Transfer

Application A Well Data Export

Seismic Navigation Data

Faults

Selecting the Well Data Management task 110 may display subtasks 112 that may include, but are not limited to:

Well Lists

Well Locations

Directional Well Data

Curves

Surfaces

Well Faults

Lease Data

Cultural Data

Production Data and Image Files

Selecting the Seismic Project and Data Management task 110 may display subtasks 112 that may include, but are not limited to:

Horizons

Faults

Merged Products

File Management

Selecting the Project Backup and Restore task 110 may display subtasks 112 that may include, but are not limited to:

Upgrading Application A Projects

Application A Project Backup & Restore

Synchronizing Application A Projects

Physical Size of Application A Projects

Seismic Project Backup

Seismic Project Restore

The Making Displays individual task page 126 may, when displayed, include one or more user-selectable items representing individual tasks 110 including, but not limited to Documenting Project Information.

The Seismic Data Enhancement individual task page 126 may, when displayed, include one or more user-selectable items representing individual tasks 110 including, but not limited to:

Building a Template in Application B

Choosing Seismic Data to Interpret

Seismic Interpretation Techniques

The Seismic Reconnaissance individual task page 126 may, when displayed, include one or more user-selectable items representing individual tasks 110 including, but not limited to:

Building a Basemap

Building a Type Log with Application L

Choosing Seismic Data to Interpret

Time-Depth Tables

Seismic Interpretation Techniques

Well Correlations

Reconciling Your Time and Depth Data

The Seismic-Well Correlation individual task page 126 may, when displayed, include one or more user-selectable items representing individual tasks 110 including, but not limited to:

Building a Basemap

Building a Template in Application B

Working with the Application B Column Editor

Log Curve Editing

Building a Type Log with Application L

Time-Depth Tables

Generating a Synthetic

Processing Data to Make it Zero-Phase

Determining Surfaces to Map

Velocity Modeling

Seismic Interpretation Techniques

Well Correlations

Contouring in Application B, Application S and Application Z

Editing

Event Matching

Reconciling Your Time and Depth Data

Integrating Seismic and Geologic Fault Interpretation

The Geologic Reconnaissance individual task page 126 may, when displayed, include one or more user-selectable items representing individual tasks 110 including, but not limited to:

Building a Basemap

Building a Template in Application B

Building Bubble Maps

Working with the Application B Column Editor

Log Curve Editing

Building a Type Log with Application L

Determining Surfaces to Map

Seismic Interpretation Techniques

Well Correlations

Reconciling Your Time and Depth Data

The Seismic Attribute Extraction individual task page 126 may, when displayed, include one or more user-selectable items representing individual tasks 110 including, but not limited to:

Seismic Interpretation Techniques

Well Correlations

Attribute Analysis

The Petrophysical Analysis individual task page 126 may, when displayed, include one or more user-selectable items representing individual tasks 110 including, but not limited to:

Building a Template in Application B

Log Curve Editing

Building a Type Log with Application L

Generating a Synthetic

Event Matching

Processing Data to make it Zero Phase

The Correlate/Extrapolate Well-Seismic Attributes individual task page 126 may, when displayed, include one or more user-selectable items representing individual tasks 110 including, but not limited to:

Building a Template in Application B

Generating a Synthetic

Event Matching

Processing Data to Make it Zero Phase

Seismic Interpretation Techniques

Well Correlations

Attribute Analysis

The Well Correlation and Cross Section individual task page 126 may, when displayed, include one or more user-selectable items representing individual tasks 110 including, but not limited to:

Building a Template in Application B

Building Bubble Maps

Working with the Application B Column Editor

Log Curve Editing

Building a Type Log with Application L

Seismic Interpretation Techniques

Well Correlations

Contouring in Application B, Application S and Application Z

Editing

Reconciling Your Time and Depth Data

Integrating Seismic and Geologic Fault Interpretation

The Seismic Structure Interpretation individual task page 126 may, when displayed, include one or more user-selectable items representing individual tasks 110 including, but not limited to:

Choosing Seismic Data to Interpret

Time-Depth Tables

Determining Surfaces to Map

Seismic Interpretation Techniques

Well Correlations

Contouring in Application B, Application S and Application Z

Editing

Rebuilding a Velocity Model with Application D

Reconciling Your Time and Depth Data

Integrating Seismic and Geologic Fault Interpretation

Velocity Modeling

The Time-Depth Conversion individual task page 126 may, when displayed, include one or more user-selectable items representing individual tasks 110 including, but not limited to:

Time-Depth Tables

Generating a Synthetic

Event Matching

Processing Data to Make it Zero Phase

Velocity Modeling

Seismic Interpretation Techniques

Well Correlations

Rebuilding a Velocity Model with Application D

Reconciling Your Time and Depth Data

The Well Path Planning individual task page 126 may, when displayed, include one or more user-selectable items representing individual tasks 110 including, but not limited to:

Building a Type Log with Application L

Well Correlations

The Geologic Mapping individual task page 126 may, when displayed, include one or more user-selectable items representing individual tasks 110 including, but not limited to:

Building a Basemap

Building Bubble Maps

Editing

Integrating Seismic and Geologic Fault Interpretation

Reconciling Your Time and Depth Data

Seismic Interpretation Techniques

Well Correlations

Contouring in Application B, Application S and Application Z

Selecting any of the abovementioned subtasks 112 on any of the abovementioned individual task pages 126 may in turn display one or more task details 114 on the macro tasks page 124 associated with the selected subtask 112.

Structural Interpretation High-level Tasks and Subtasks

In one embodiment directed towards the geology and geophysical area of the oil and gas industry, the task-centric online environment may include a macro tasks page 124 for structural interpretation. This page may include items representing high-level tasks 110 that may include, but are not limited to:

Data Reconnaissance

Data Conditioning

Initial Interpretation

Putting it All Together

Making Displays

Selecting the Data Reconnaissance high-level task 110 may display subtasks 112 that may include, but are not limited to:

Building a Basemap

Building a Template in Application B

Building Bubble Maps

Working with the Application B Column Editor

Log Curve Editing

Building a Type Log with Application L

Choosing Seismic Data to Interpret

Selecting the Data Conditioning high-level task 110 may display subtasks 112 that may include, but are not limited to:

Time-Depth Tables

Generating a Synthetic

Event Matching

Processing Data to Make it Zero-Phase

Selecting the Initial Interpretation high-level task 110 may display subtasks 112 that may include, but are not limited to:

Determining Surfaces to Map

Velocity Modeling

Seismic Interpretation Techniques

Horizons: Overview and Introduction

Mapping with Application M

Well Correlations

Contouring in Application B, Application S and Application Z

Editing

Selecting the Putting it All Together high-level task 110 may display subtasks 112 that may include, but are not limited to: Putting it All Together

Rebuilding a Velocity Model with Application D

Reconciling Your Time and Depth Data

Attribute Analysis

Integrating Seismic and Geologic Fault Interpretation

Selecting the Making Displays high-level task 110 may display subtasks 112 that may include, but are not limited to:

Documenting Project Information

Printing Your Displays

Selecting any of the abovementioned subtasks 112 may in turn display one or more task details 114 on the macro tasks page 124 associated with the selected subtask 112. Note that other fields of endeavor may each have their own set of macro tasks, tasks, and subtasks.

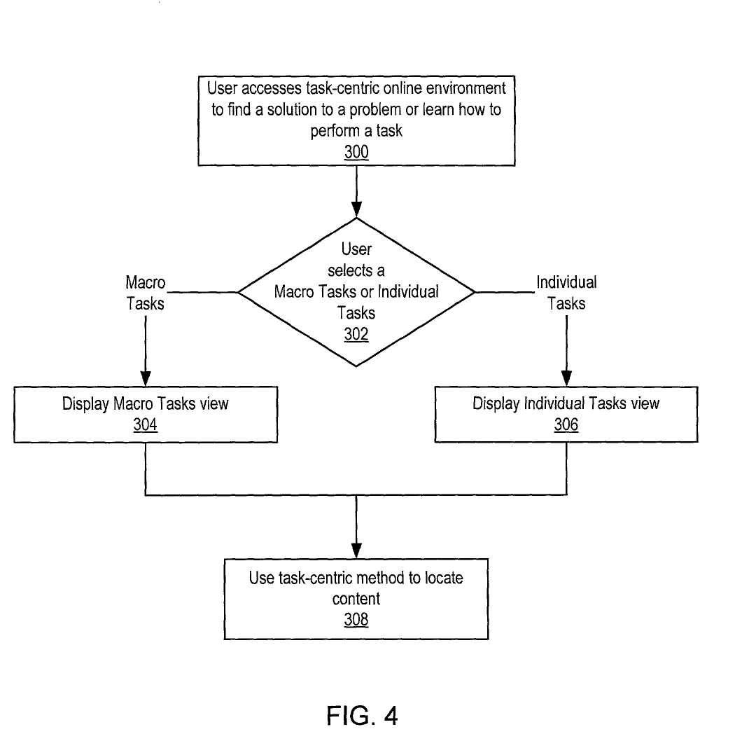

FIG. 4—A Method of Using Individual Tasks Pages and/or Macro Tasks Web Pages

FIG. 4 is a flowchart illustrating a method of using the individual tasks pages 122 and/or a macro tasks page 124 of the task-centric online environment according to one embodiment. In one embodiment, the task-centric online environment may be directed towards the geology and geophysical area of the oil and gas industry. As indicated at 300, the end user may first access the task-centric online environment to find a solution to a problem or learn how to perform a task. In one embodiment, the end user may enter the task-centric online environment by selecting a link to the task-centric online environment from another web page of the company's web site. Alternatively, the end user may enter a URL in a browser window to access the task-centric online environment. One skilled in the art will recognize that there are other methods for accessing a web site or web page from a client system. When first entering the task-centric online environment, the end user may be presented with a challenge-response. For example, a web page may be presented that requires the user to enter a valid user name and password before access is allowed to other web pages in the task-centric online environment.

Once in the task-centric online environment, the end user may select a link to either Macro Tasks or Individual Tasks as indicated at 302. In one embodiment, a home page 120 may be displayed on the end user's browser window. The home page 120 may include user-selectable links to one or more Macro Tasks pages 124 and/or to one or more Individual Tasks pages. If the end user selects a link to a Macro Tasks page, then the macro tasks page 124 may be displayed on the end user's browser window as indicated at 304. If the end user selects a link to an Individual Tasks page, then the individual task page 122 may be displayed on the end user's browser window as indicated at 306.

As indicated at 308, the end user, whether performing individual tasks or macro tasks, may then proceed to use the task-centric online environment to locate knowledge base content 116 relevant to the problem or task that the end user is interested in.

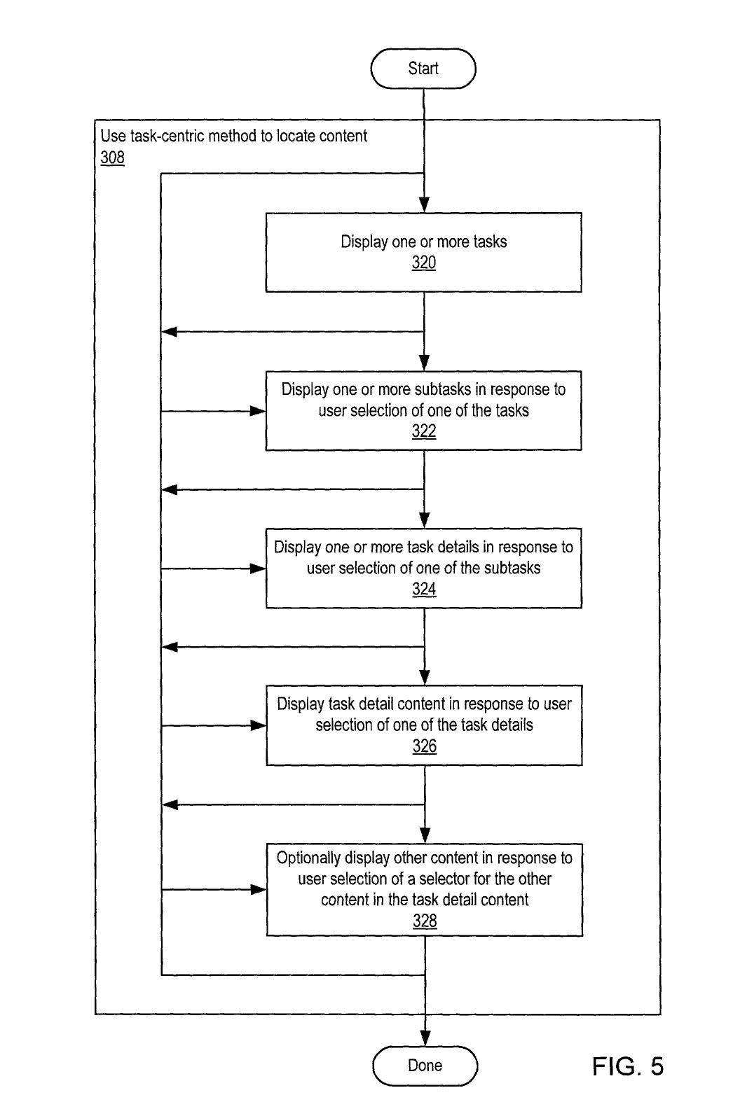

FIG. 5—A Method of Using the Task-centric Online Environment

FIG. 5 is a flowchart illustrating a method of using the task-centric online environment to locate information (content) for use in task resolution and problem solving according to one embodiment. The flowchart of FIG. 5 expands on 308 of FIG. 4. In one embodiment, the task-centric online environment may be directed towards the geology and geophysical area of the oil and gas industry. As indicated at 320, one or more tasks 110 may be displayed at a first navigation level. If the end user is using Individual Tasks to find a solution to a specific problem, then the tasks 110 are individual tasks and are displayed in an individual tasks page 122. Individual tasks are specific tasks within a work area or process. If the end user is using Macro Tasks, then the tasks 110 are high-level tasks and are displayed in a macro tasks page 124. High-level tasks present a macro view of various integration steps and applications involved in a work area, for example structural interpretation (interpreting structure in an oil and gas play).

As indicated at 322, the user may select one of the one or more tasks 110. In response to the selection, one or more subtasks 112 of the task 110 may be displayed. If the user is using Individual Tasks, then an individual task page 126 is opened, and the subtasks 112 are displayed in the individual task page 126. If the user is using Macro Tasks, then the subtasks 112 are displayed in the macro tasks page 124.

As indicated at 324, the user may select one of the one or more displayed subtasks 112. In response to the selection, one or more task details 114 of the subtask 112 may be displayed. If the user is using Individual Tasks, then the task details 114 are displayed in the individual task page 126. If the user is using Macro Tasks, then the task details 114 are displayed in the macro tasks page 124.

As indicated at 326, the user may select one of the one or more displayed task details 114. In response to the selection, a task detail content page 128 may be displayed. The task detail content page 128 may include detailed information relevant to the selected task detail 114. The task detail content page 128 may include body text. The body text may include selectors such as links that are user-selectable display other task detail content pages 128, or other web pages or documents. The task detail content page 128 may also include content item selectors (e.g. thumbnails, icons and/or other textual or graphical objects) that are user-selectable to display data such as images (e.g. GIF, JPEG, etc.), printable files (e.g. PDF files), video presentations and audio presentations. Optionally, as indicated at 328, the end user may choose to display other content items and/or web pages by selecting one or more content item selectors or other selectors in the task detail content page 128. In one embodiment, the other content items and web pages may be displayed in a separate display.

Note that anywhere within the method as illustrated in FIGS. 4 and 5, the end user may go up or down in the task hierarchy presented by the task-centric online environment. For example, an end user may view task details 114 for a particular subtask 112 as indicated at 324. The end user may determine that the particular content he or she is interested in is not in this subtask 112. The end user may choose to go up a level by selecting a different subtask 112, or may even go up two levels by selecting a different task 110 if there is more than one task 110 displayed.

The end user may choose to add various interesting or relevant content to his or her personal binder. For example, when the user is viewing a particular content page 128, a link to the content page 128 may be added to the end user's personal binder by selecting the “Add to Personal Binder” item on the web page template.

The methods as described in FIGS. 4 and 5 may be implemented in software, hardware, or a combination thereof. The order of method may be changed, and various steps may be added, reordered, combined, omitted, modified, etc.

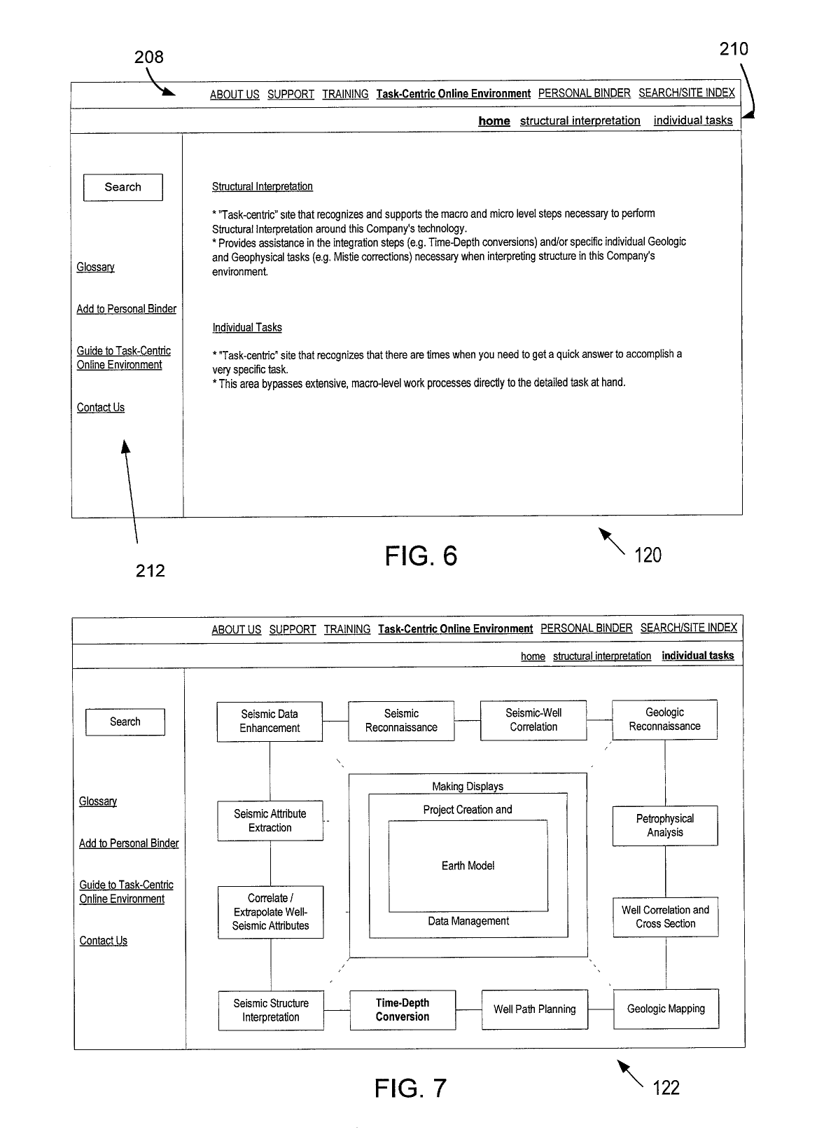

FIGS. 6 through 16—An Exemplary Task-centric Online Environment

FIGS. 6 through 16 illustrate several web pages in an exemplary task-centric online environment directed towards the geology and geophysical area of the oil and gas industry according to one embodiment. In these figures, text items that are bold represent currently selected or active items, and text items that are underlined represent items that are links to other web pages or alternatively links to another location in the current web page.

FIG. 6—An Exemplary Home Page

FIG. 6 illustrates an exemplary home page 120 of a task-centric online environment directed towards the geology and geophysical area of the oil and gas industry according to one embodiment. When an end user enters the task-centric online environment, the home page may be displayed on the end user's browser. Options presented to the end user on the home page may include a link to a structural interpretation page 124 and a link to an individual tasks page 122.

A company's web site that provides a task-centric online environment may present several interface items to the user for navigating among the various features and levels of the web site, for performing functions, and for customizing the appearance, contents, and/or behavior of the web site. Interface items 208 may allow the user to select among several areas of the web site such as Support, Training, a task-centric online environment, a personal binder, and a Search/Site Index. Interface items 212 may allow the user to perform several functions including adding items to the Personal Binder, viewing a glossary, participating in a user forum, going to third-party links, performing searches, etc. FIG. 6 shows the task-centric online environment as being selected, and thus the web site displays the home page 122 of the task-centric online environment.

In one embodiment, the interface items as shown for the home page 120 of FIG. 4 may be included in the web page template that is used for individual tasks pages 122, individual task pages 126, macro tasks pages 124 and content pages 128 in the data-centric online environment. Thus, the interface items 208 and 212 may be in the user interface presented by these pages. In one embodiment, detailed content information accessed from content pages 128 may be presented to the end user in separate web pages on the end user's browser, and may not use the web page template used for the other pages described above.

The personal binder provides the end user with one or more personal web pages. If the end user finds web pages (e.g. content pages 126) that he or she wishes to keep track of and/or needs to frequently revisit, the end user may store them in the personal binder. The personal binder is also where the end user may control the personalization features of the task-centric online environment, such as the ability to subscribe to specific corporate information (example: Usernet newsletters).

In one embodiment, when an end user selects the task-centric online environment or the personal binder, the user may first be presented with a login page. The user may be required to enter a user name, password, and possibly other information to access the task-centric online environment.

FIG. 7—Exemplary Individual Tasks Page

FIG. 7 illustrates an exemplary individual tasks page 122 with user selectable items each representing an individual task that link to a plurality of individual task pages 126 in a task-centric online environment directed towards the geology and geophysical area of the oil and gas industry according to one embodiment. The individual tasks may be used by the end user to attempt to get the best simulation of what the environment is like below ground (e.g. in a field) from a set of data (seismic data, well data, etc.). These tasks may be required in doing interpretation, and may be divided into:

Tasks in reconnaissance. The end user is trying to find out what's available or what's possible. The end user may have a set of data, and needs to figure out areas to focus more attention.

Tasks for correlating and creating cross sections using well data to figure out what the surface is doing between wells.

The individual tasks page 122 is the first level of navigation for individual tasks. Selecting an item representing an individual task displays an individual task page 126 with the next two levels of navigation (subtopic and task details) for the particular individual task. Time-Depth Conversion is shown as the currently selected item. User input selecting this item causes the time-depth conversion individual task page 126 illustrated in FIG. 7 to be displayed.

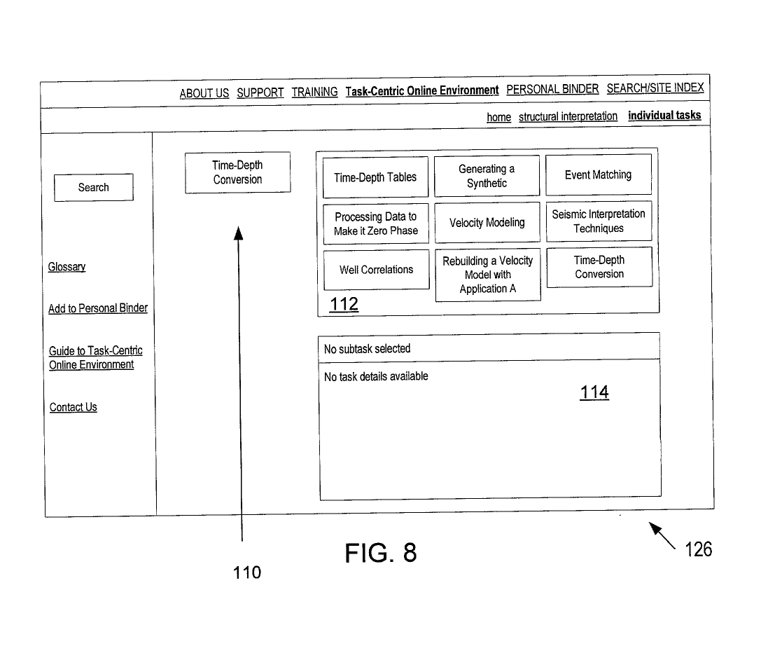

FIG. 8—An Exemplary Individual Task Page

FIG. 8 illustrates an exemplary individual task page 126 in a task-centric online environment directed towards, in this instance, the geology and geophysical area of the oil and gas industry according to one embodiment. This individual task page 126 show two levels of navigation for the time-depth conversion individual task. This example shows several subtasks 112 for time-depth conversion. No subtask 112 is currently selected, so no task details 114 are shown on the page. Selecting one of the subtasks 112 will display one or more task details 114 of the selected subtask 112. This page is designed to provide unique tiered navigation that is more outcome-driven than prior art systems. The end user needs to know only what final outcome is desired, rather than needing to know in advance a series of steps and products that may be used in performing the steps, to generate an outcome. For example, an end user may start only knowing that he or she needs to build a basemap rather than having to know that he or she needs to create contours, plot wells, perform coordinate transformations, etc.

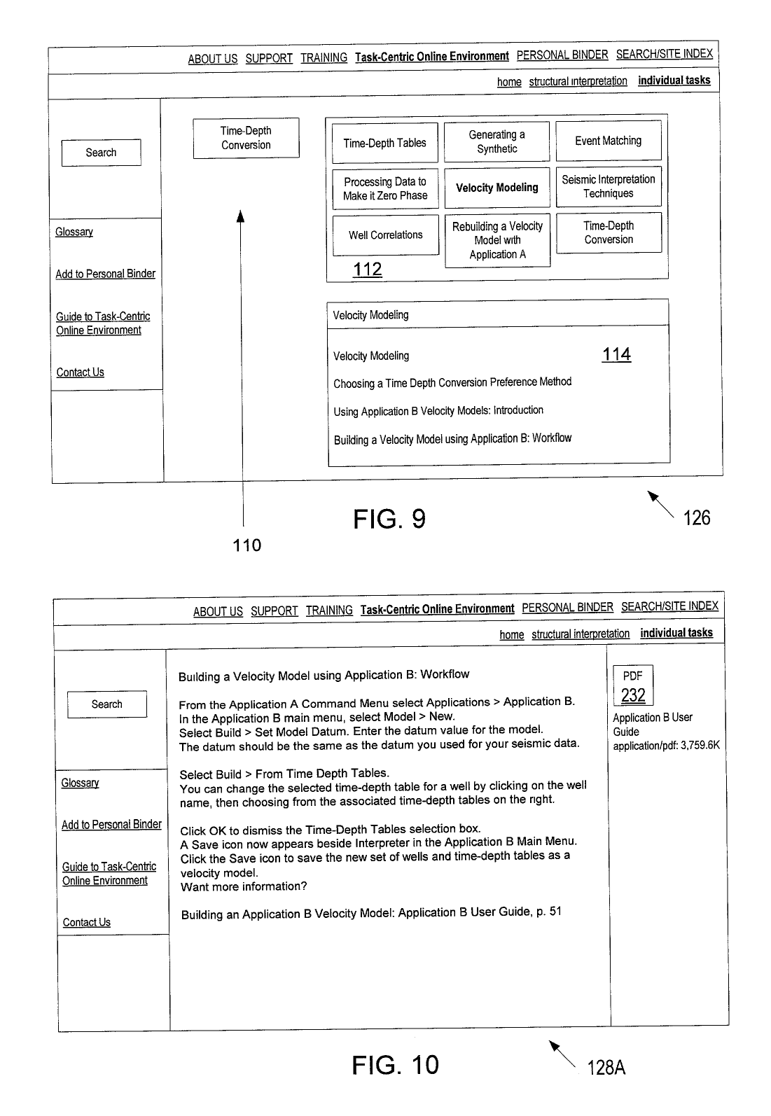

FIG. 9—An Exemplary Individual Task Page with a Subtask Selected

FIG. 9 illustrates an exemplary individual task web page with a subtask 112 of the individual task selected to display task details 114 for the subtask 112 in a task-centric online environment directed towards the geology and geophysical area of the oil and gas industry according to one embodiment. This example shows Velocity Modeling as the currently selected subtask 112. Several task details 114 are shown for the Velocity Modeling subtask 112. The subtasks 112 may represent outcomes of what the end user may create. Subtasks 112 may also be referred to as “topics” within the individual task. The task details 114 may include links to various associated content documents (detail) which may come from groups within the vendor (e.g. training, professional services, customer support, R&D, etc.). The content documents linked to by the task details 114 include information relevant to the selected subtask 112 of the individual task.

As an example of using the individual tasks, an end user may want to perform Time-Depth conversion. The end user may have some seismic data and may need to put it into equivalent depth values so that the end user can, for example, estimate where to drill a well to. When the end user selects the time-depth conversion individual task from the individual tasks page 122, the time-depth conversion individual task page 126 is displayed. The task page 126 displays several different subtasks 112 of time-depth conversion. When a particular subtask 112 is selected, then one or more task details 114 that include information concerning what the vendor may do and/or provide in the particular area of the subtask 112 may be displayed for the selected subtask 112. For example if the end user is involved in doing velocity modeling, the user may select the Velocity Modeling subtask 112, and various task details 114 related to velocity modeling may be displayed for the end user to select from. These task details 114 may include guidance on the science, guidance on the tools offered by the vendor, etc. Selecting an item of task detail 114 may display a content page 128 to the end user showing the content (detailed information) of the particular task detail item. For example, the end user might select the Building a Velocity Model using Application B: Workflow task detail item to display the content page 128A illustrated in FIG. 10.

FIG. 10—A Content Page

FIG. 10 illustrates an exemplary content page 128A accessed from the task details 114 of FIG. 9 in a task-centric online environment directed towards the geology and geophysical area of the oil and gas industry according to one embodiment. Content page 128A shows detailed information for the “Building a Velocity Model using Application B: Workflow” task detail item as described in FIG. 9. Content page 128A illustrates the next level of problem solving in the task-centric online environment. This level may be viewed as a more specific problem-solving layer.

In one embodiment, content pages 128 may conform to a template design. The template design may play an important role by helping to simplify content information by creating consistency in content presentation. Content documents may be formatted with “copy chunking” to make content as simple as possible. Hypertext and/or hyperlinks may be included in the text that may provide links to more detailed information. The text may also include links to other content pages 128 and/or to other locations within the current content page 128. Copy chunking and links help to reduce heavily formatted documents such as manuals to a simpler format. The template design may promote ease of use, for example by compressing information to thus reduce scrolling.

Content page 128A may also include thumbnails, icons and/or other textual or graphical objects (hereinafter referred to as content item selectors) that are user-selectable to display other, possibly more detailed content items such as graphic images 130 (GIF, JPEG, screens shots, diagrams, etc.), documents 132 (e.g. PDF user manuals), video presentations 134, and audio presentations 136. For example, content page 128A includes an icon 232 which, when selected, displays the PDF file “Application B User Guide”.

Content item selectors may serve several purposes. The content item selectors may be used to remove graphical items from within the document text to help reduce the document to a simpler format. The content item selectors may also be used as links to more detailed information such as full, printable PDF versions of user manuals or to video (e.g. Flash) or audio presentations. In one embodiment, the content item selectors may be located next to the text at positions near where they are referred to in the text. In one embodiment, the content item selectors may be positioned to the right of the text. Thus, when an end user scrolls down through the text, the end user may see content item selectors positioned next to where they are referred to in the text. As the page expands, the story line follows the image line, so as the end user reads the document, they know what images relate to the portion of the document they are reading. That way the user does not have to hunt for images in the body text. Copies of images may appear more than once at different portions of the document, so, in one embodiment, if an end user encounters a reference to the image in the document, the image may be located next to the relevant portion of the document.

If an end user locates a valuable piece of information, the user may choose to add a link to the information to their personal binder by selecting the “Add to Personal Binder” item. The end user may be prompted as to what to call the link and in what category to store it. Preferably, there are predefined categories (tabs) to store information in the personal binder. In one embodiment, the end users may also create their own categories.

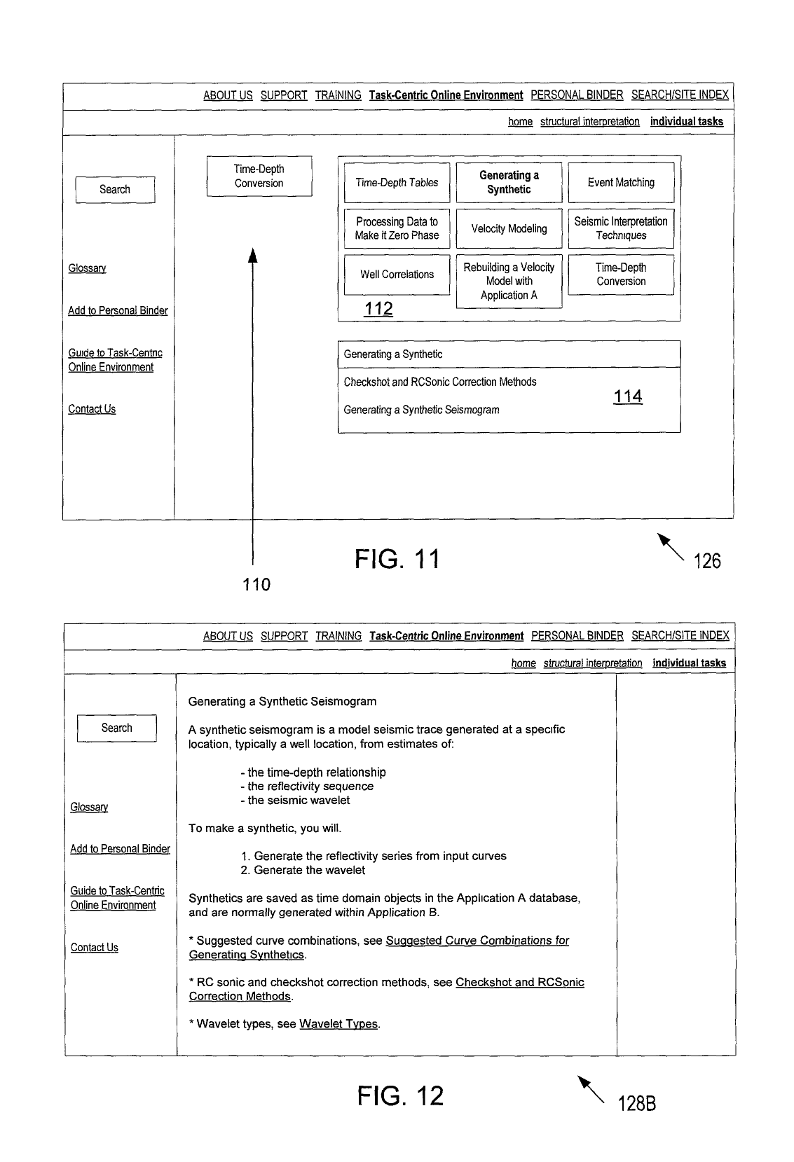

FIG. 11—The Exemplary Individual Task Page with a Different Subtask Selected

FIG. 11 illustrates the exemplary individual task web page 126 with another subtask 112 of the individual task selected to display task details 114 for the subtask 112 in the task-centric online environment directed towards the geology and geophysical area of the oil and gas industry according to one embodiment. As an example of using the individual tasks in the task-centric online environment, the end user may be working a particular play in the area of time-depth conversion. The end user may select the Time-Depth conversion individual task from the individual tasks page 122. The end user may examine the different subtasks 112. The end user may need to generate a synthetic to match different events or horizons in the surface, etc. The vendor may provide a particular technology X that is configured for use in the area of synthetics. The individual task page 126 does not say “use technology X to generate a synthetic.” The end user instead sees the subtask 112 “Generate a Synthetic”. When the user selects this subtask 112, task details 114 for the subtask 112 may be displayed that may include information on some of the things that are required or recommended in generating a synthetic including links to more detailed information contained in the content pages “Checkshot and RCSonic Correction Methods” and “Generating a Synthetic Seismogram”. At this level names of applications that are provided by the vendor may first be shown to the end user. In this example, the end user may select “Generating a Synthetic Seismogram” to display the exemplary content page 128B illustrated in FIG. 12.

FIG. 12—Another Content Page

FIG. 12 illustrates another exemplary content page 128B accessed from the task details 114 of FIG. 11 in a task-centric online environment directed towards the geology and geophysical area of the oil and gas industry according to one embodiment. This content page 128B shows detailed information for the “Generating a Synthetic Seismogram” task detail item as described in FIG. 11. Content page 128B shows detailed information that the end user may use in generating a synthetic seismogram. Note that the body text includes references to vendor applications. Content page 128B may also include links to other documents in the knowledge base (e.g. other content pages 128) within the body text, such as graphic images 130, documents 132, video presentations 134, and audio presentations 136.

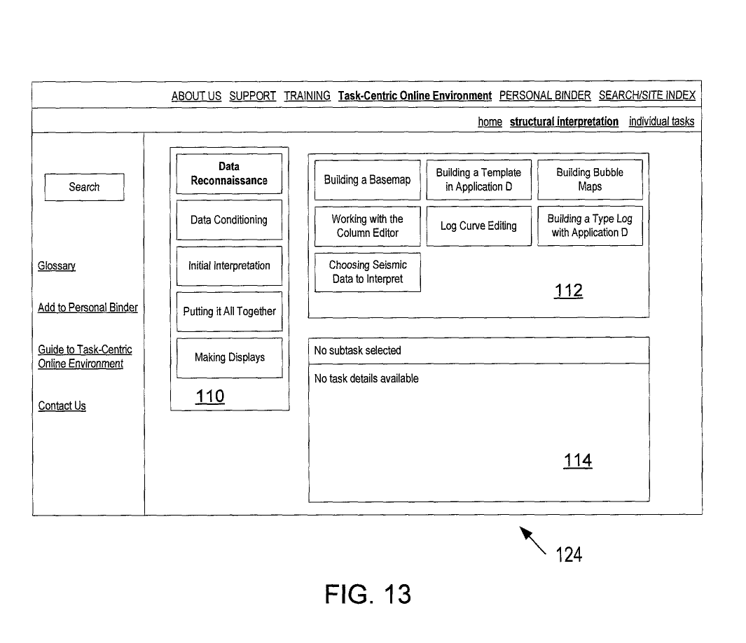

FIG. 13—A Macro Tasks Web Page

FIG. 13 illustrates an exemplary macro tasks page 124 for the structural interpretation work area in a task-centric online environment directed towards the geology and geophysical area of the oil and gas industry according to one embodiment. Note that “Structural Interpretation” is selected in the web page to display the structural interpretation macro tasks page 124. Organizational-based websites cause the user to drill down layer after layer to obtain an answer. The unique navigation scheme provided by the macro tasks page 124 is task-centric and supports multiple levels of detail from high-level tasks to detailed user manuals. The macro tasks page 124 show three levels of navigation for the structural interpretation work area (high-level tasks 110, subtasks 112 and task details 114). Several high-level tasks 110 are displayed. The “Data Reconnaissance” task 110 is currently selected. Several subtasks 112 for Data Reconnaissance are displayed. No subtask 112 is currently selected, so no task details 114 are shown on the page. Selecting one of the subtasks 112 may display one or more task details 114 of the selected subtask 112. In one embodiment, the user interface provided by the macro tasks page 124 is may be similar to that provided by the individual task pages 126, thus providing a common user interface for the different task navigation methods.

A macro tasks page 124 provides macros of tasks and outcomes (subtasks), but, in one embodiment, may not piece together which ones the user should do in what order. When performing structural interpretation, the user is trying to figure out the reservoir “container” (i.e. the top surface and bottom surface of where the oil or gas is contained). There may be several high-level macro tasks involved in the process, but the tasks performed and the order the tasks are performed may vary when applied to different reservoirs. The structural interpretation view shows the integration between the different high-level tasks. Structural interpretation may include several high-level tasks which, in one embodiment, may be arranged to indicate the relationship between the tasks. In one embodiment, the high-level tasks may be arranged in a logical start-to-finish order that may allow the end user to step thru the tasks, select desired individual topic or subtask 112 related to the particular high-level task, and access and view particular detail items of the selected topics as a method of finding a solution to the end user's particular problem. But, in one embodiment, structural interpretation may not force the ordering of the high-level tasks on the end user. The end user may choose to skip one or more high-level tasks and/or perform the tasks in different orders.

A macro tasks page 124 (e.g. the structural interpretation page) may be designed to provide tiered navigation that is more outcome-driven than prior art systems. The end user needs to know only what final outcome is desired, rather than needing to know in advance a series of steps, and products that may be used in performing the steps, to generate an outcome. For example, an end user may start only knowing that he or she needs to build a basemap rather than having to know that he or she needs to create contours, plot wells, etc.

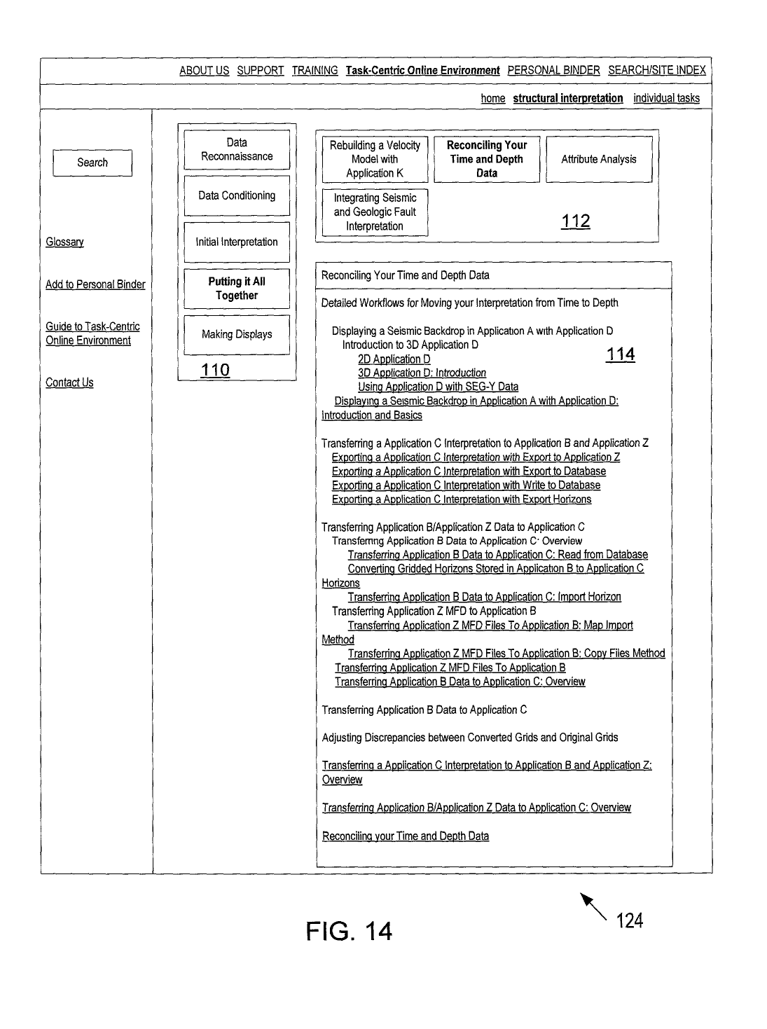

FIG. 14—A Macro Tasks Web Page with High-level and Subtask Selected

FIG. 14 illustrates an exemplary macro tasks page 124 for the structural interpretation work area in a task-centric online environment directed towards the geology and geophysical area of the oil and gas industry according to one embodiment. In this example, a high-level task 110 (“Putting it All Together”) is selected to display the subtasks 112 of the “Putting it All Together” high-level task. One of the subtasks 112 of the selected high-level task (“Reconciling Your Time and Depth Data”) is selected to display the task details 114 of the selected subtask 112.

Macro tasks such as those presented for structural interpretation may be at a higher level than individual tasks. The macro tasks may include detailed information about the integration among the vendor's various products. A vendor may provide any number of products into the hundreds. When a customer is doing a macro level task such as structural interpretation, they may use a subset (e.g. 25) of the vendor's products (e.g. applications, tools and services). While the vendor's products may be integrated, sometimes, to the end user, moving from an application X to and application Y to an application Z may not be straightforward. The macro tasks page 124 (e.g. structural interpretation) helps to define the relationships.

For example, the macro (high-level) task “Putting it all Together” may include information about using the different applications required for reconciling seismic data to well data. There may be one suite of applications that may be used for interpreting seismic data, and another suite directed at interpreting well data. The end user may first select the “Putting it All Together” high-level task and then select the “Reconciling Your Time and Depth Data” subtask 112. When the “Reconciling Your Time and Depth Data” subtask 112 is selected, task details 114 of the subtask 112 are displayed. In one embodiment, the task details 114 may be displayed in the structural interpretation macro tasks page 124. The “Reconciling Your Time and Depth Data” subtask 112 may involve a plurality of the vendor's products. The task details 114 for the subtask 112 may be directed at the integrated use of the vendor's products to perform the selected subtask 112. The task details 114 may show things the end user needs to do and things the end user shouldn't do. The task details 114 may show some examples of consequences of not performing the task properly. The task details 114 may include one or more links to content pages 128 that each include more detailed information about a particular detail of the subtask 112. In one embodiment, the task details 114 may also include links to other web pages and/or documents inside or optionally outside the vendor's web site.

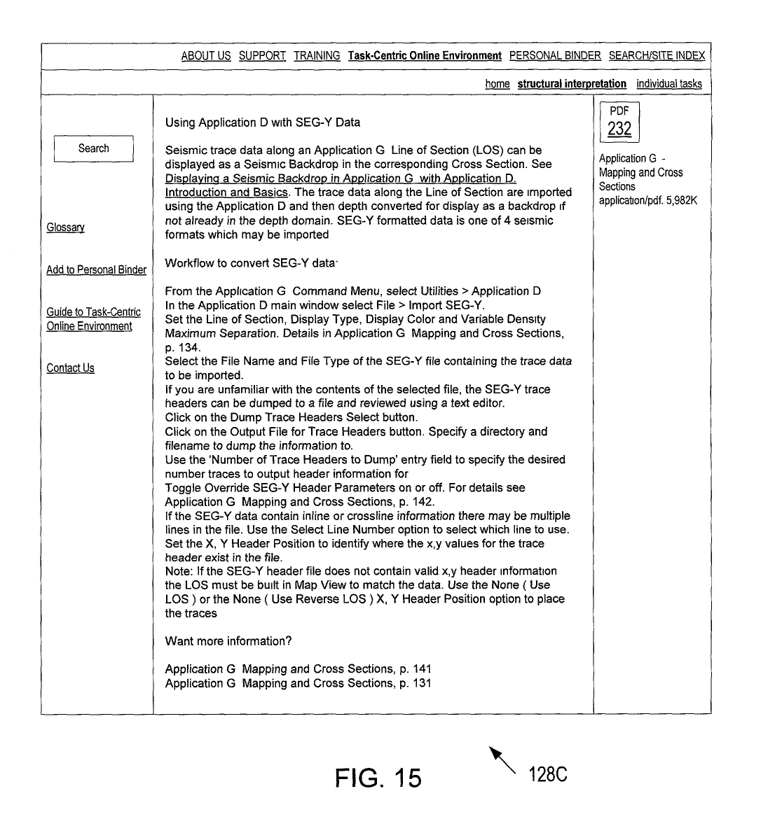

FIG. 15—An Exemplary Content Page

FIG. 15 illustrates an exemplary content page 128C of the structural interpretation work area in a task-centric online environment directed towards the geology and geophysical area of the oil and gas industry according to one embodiment. Content page 128C may be displayed when the end user selects the “Using Application D with SEG-Y Data” task detail 114 of FIG. 14. In one embodiment, the content page 128C may be displayed in a separate browser window from the macro tasks page 124. The content page 128C includes detailed body text related to the selected task detail. The body text may include links to other portions of the body text, to other content pages 128, and/or to other documents and web pages. A content page may also include content item selectors that, when selected, display content items such as graphic images 130 (e.g. GIF or PDF images), documents 132 (e.g. PDF documents), video presentations 134, and audio presentations 136. In one embodiment, the content items may be displayed in separate displays such as browser windows. For example, the content page 128C includes an icon 232 that, when selected, displays the PDF document “Application G Mapping and Cross Sections”.

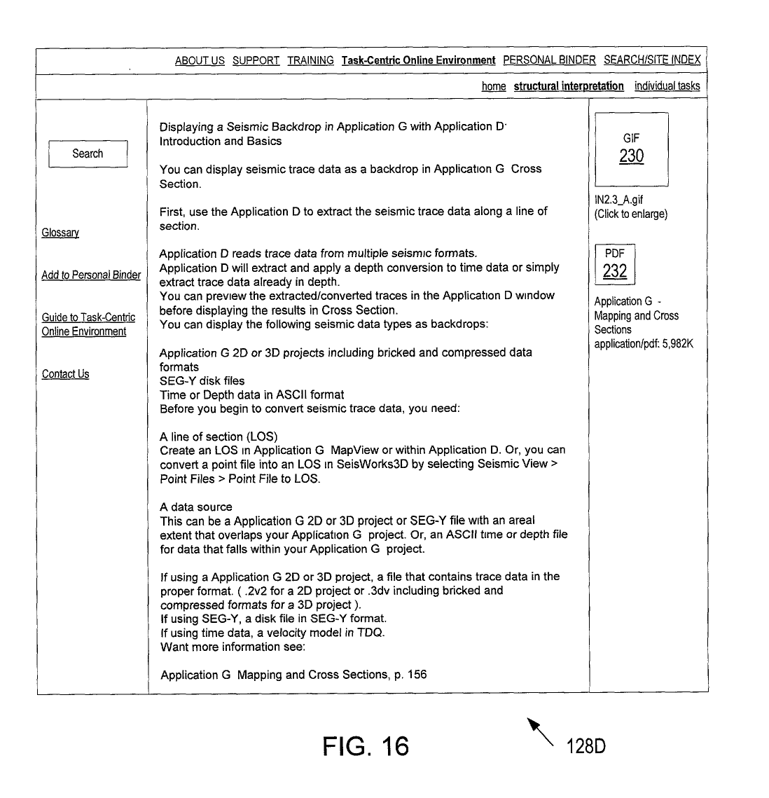

FIG. 16—Another Exemplary Content Page

FIG. 16 illustrates another exemplary content page 128D of the structural interpretation work area in a task-centric online environment directed towards the geology and geophysical area of the oil and gas industry according to one embodiment. Content page 128D may be displayed when the end user selects the “Displaying a Seismic Backdrop in Application A with Application D: Introduction and Basics” task detail 114 of FIG. 14. In one embodiment, the content page 128D may be displayed in a separate browser window from the macro tasks page 124 and from other content pages 128 that may be currently open. The content page 128D includes detailed body text related to the selected task detail. The body text may include links to other portions of the body text, to other content pages 128, and/or to other documents and web pages. A content page may also include content item selectors that, when selected, display content items such as graphic images 130 (e.g. GIF or PDF images), documents 132 (e.g. PDF documents), video presentations 134, and audio presentations 136. In one embodiment, the content items may be displayed in separate displays such as browser windows. For example, the content page 128D includes an icon 132 that, when selected, displays the PDF document “Application G—Mapping and Cross Sections”. The content page 128D also includes a thumbnail 230 of an image 130 which may be related to the body text. When the thumbnail 230 is selected, the image is displayed.

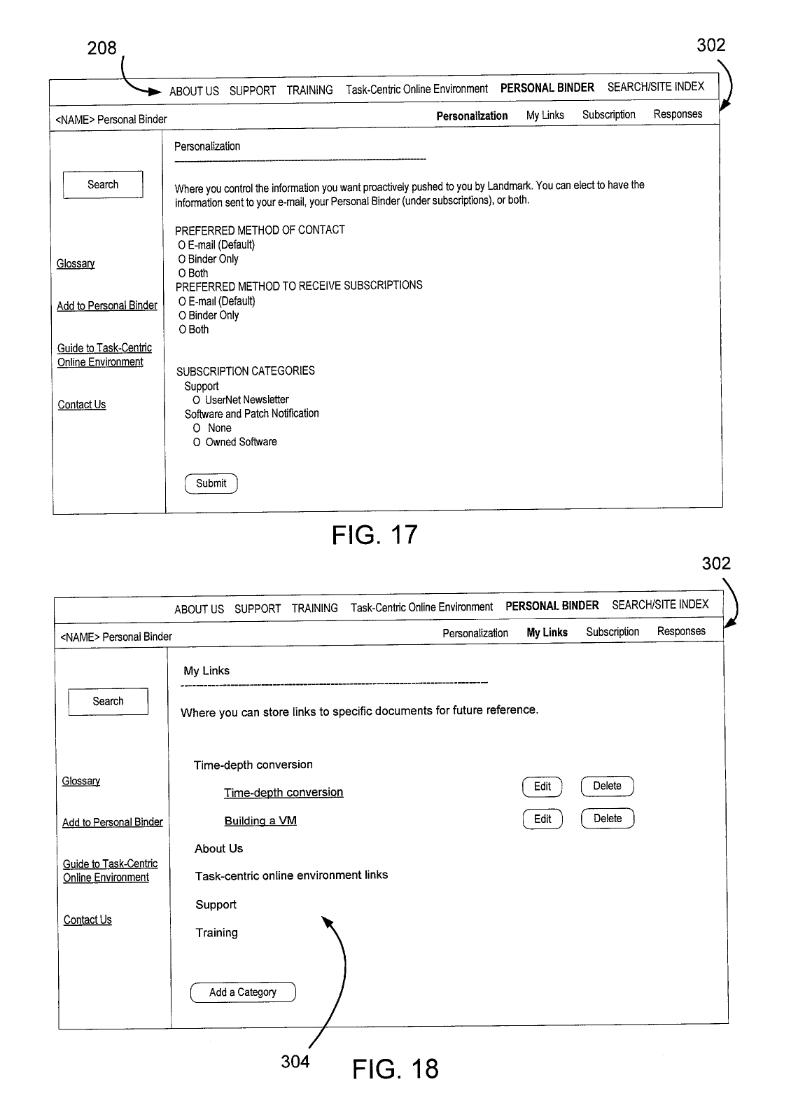

FIG. 17—Personal Binder Personalization Page

FIG. 17 illustrates an interface to a personal binder according to one embodiment. In one embodiment, a role of the personal binder is to emulate the physical binder that is typically used by geologists and geophysicists, where they print out key pieces of information frequently referenced and store for easy access. In the task-centric online environment, once a key piece of information is found, the user has the ability to store the link in their personal binder (see above) so that they are not forced to re-navigate through the system again. The personal binder may also store responses to the particular customer's specific questions. In one embodiment, the user may add and/or delete interface items and customize the user interface in other ways. Some embodiments may have predefined interface items. In this embodiment, several navigation items 302 may be presented to the user to allow the user to select one or more web pages, wherein each web page displays one or more features of the personal binder. Alternatively, selecting a navigation item 302 may change the appearance and contents of a portion of the personal binder web page. For example, the personalization item is selected, displaying several interface items that allow the user to personalize the appearance, behavior and/or contents of the user's personal binder. Other navigation items 302 may display web pages that show links the end user has added to the personal binder, news, etc. that the end user has subscribed to, and/or responses to requests for information that the user has submitted. Access to one or more features of the personal binder may be protected by requiring a user ID and/or password.

FIG. 18—A Personal Binder Links Page

FIG. 18 illustrates an exemplary personal binder links page according to one embodiment. If an end user locates a valuable piece of information within the task-centric online environment, the end user may choose to add the information to their personal binder. The end user may be prompted for what to call the link, and in what category to store it. There may be predefined categories to store links in the personal binder. Alternatively, the end users may also create their own categories. The “My Links” page in the personal binder may show all categories and list the links within the categories. The end user may then access pieces of information (content) that were added from the task-centric online environment by selecting the links. That way the end user does not have to remember where he or she was in the task-centric online environment when the content was located.

In one embodiment, the interface to the personal binder may be presented to the user as a web page in response to the user selecting a user interface item on a previous web page. Alternatively, the user may enter a URL to the personal website. Access to one or more features of the personal binder user may be protected by requiring a user ID and/or password. Several interface items 302 may be presented to the user to allow the end user to select one or more web pages, wherein each web page displays one or more features of the personal binder. Alternatively, selecting an interface item 302 may change the appearance and contents of a portion of the personal binder web page. In the example illustrated in FIG. 18, the interface items 302, when selected, may change the appearance and contents of a portion of the web page. In one embodiment, selecting an interface item 302 may actually navigate to a different web page, but to the end user, it may appear that only a portion of the personal binder web page has changed.

An exemplary “My Links' page is displayed in FIG. 10. Several categories are shown in the links section 304. The categories include a custom category, Time-depth conversion. The user has previously added two links to this section (Time-depth conversion and Building a VM). Selecting one of the links will take the user to the content page 128, or alternatively to the individual task page 122 or macro tasks page 124, specified by the link. The “My Links page may also include one or more user-selectable items to add and/or delete categories and one or more user-selectable items for each link to allow the end user to edit and/or delete a specific link.

Purchasing Products or Services

In one embodiment, a user (generally an administrator) of the task-centric online environment may purchase products or services through the online environment. The products or services may be provided as a delivered product, or alternatively may be provided as a service provided in the online environment using a model similar to the Application Service Provider (ASP) model in which an application is provided to a user through a website interface (the application code itself is not delivered to the client). In one embodiment, the online environment is an Internet website comprising one or more web pages.

The user may proceed through a pre-purchase phase, a purchase phase, and a post-purchase phase. In the pre-purchase phase, the online environment may provide a method to map the customer's wants and needs to information about products or services to be potentially purchased. Marketing information, education and training information, and support information may be provided to the user. In one embodiment, the information may be provided in response to selective input from the user. For example, the user may be presented with a series of questions about the user's potential use of the product or service the user is researching for purchase. This query process may navigate the user through one or more web pages of the online environment.

In the purchase phase, the sales and delivery process may be integrated into the task-centric online environment to provide a positive user experience during the process. The purchase process may interact with the user to facilitate the licensing, distribution, financing, and legal (including contracts) aspects of the purchase of the product or service.

In the post-purchase phase, the online environment may provide a method to deliver information and appropriate services to help ensure a positive experience in the online environment for the user. Interfaces in the online environment may provide support, education, training, licensing and distribution, and legal and contract documents to the end user.

In summary, a system and method for providing a task-centric online environment have been disclosed. It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

What is claimed is:

1. A computer-based method for assisting end users in performing tasks related to the upstream exploration and production areas of the oil and gas industry, the method comprising:
accessing a first display, the first display comprising:
one or more task items, wherein each of the one or more task items specifies a particular task related to the upstream exploration and production areas of the oil and gas industry; and
one or more subtask items each associated with a first task specified by a currently active task item of the one or more task items, wherein each of the one or more subtask items specifies a particular subtask of the first task, wherein each of the one or more subtask items is user-selectable to display task details of the particular subtask specified by the subtask item;
selecting a first subtask item of the one or more subtask items associated with the first task in response to a first user input; and
displaying one or more task detail items of a first subtask specified by the first subtask item in response to said selecting the first subtask item, wherein each of the one or more task detail items are user-selectable to display one of a plurality of task detail displays associated with the particular task detail item;
wherein the plurality of task detail displays each comprises information for use in assisting the end users in performing one or more portions of at least one of the tasks related to the upstream exploration and production areas of the oil and gas industry.

2. The method of claim 1, further comprising:
selecting a first task detail item of the one or more task detail items in response to a second user input; and
displaying a first task detail display in response to said selecting the first task detail item, wherein the first task detail display comprises information about one or more products or services provided by a vendor, and wherein the information is related to performing one or more particular tasks related to the upstream exploration and production areas of the oil and gas industry.

3. The method of claim 2, wherein the first task detail display comprises textual information configured for use in finding a solution to a particular problem related to the upstream exploration and production areas of the oil and gas industry.

4. The method of claim 2, wherein the first task detail display comprises one or more icons which are each user-selectable to display additional information configured for use in finding a solution to a particular problem related to the upstream exploration and production areas of the oil and gas industry.

5. The method of claim 4, wherein the additional information includes one or more of textual information, graphical information, video information and audio information.

6. The method of claim 2, wherein the first task detail display comprises one or more items which are user-selectable to display other task detail displays.

7. The method of claim 2, wherein the first task detail display comprises one or more items which are user-selectable to display another portion of the first task detail display.

8. The method of claim 2, further comprising:
providing one or more personal displays for the end user; and
the end user adding a link to the first task detail display to one of the one or more personal displays.

9. The method of claim 8, wherein the personal displays are web pages provided by a web server.

10. The method of claim 1, wherein the information comprised in each task detail display includes information about one or more of products or services configured for use in the upstream exploration and production areas of the oil and gas industry.

11. The method of claim 10, wherein each of the plurality of task detail displays is associated with one or more of a plurality of task detail items, wherein each of the plurality of task detail items is associated with one of a plurality of subtask items, and wherein each of the plurality of subtask items is associated with one of the plurality of individual task items.

12. The method of claim 1, wherein the tasks are specific tasks, and wherein the method further comprises, prior to said accessing the first display:
accessing a second display comprising a plurality of individual task items, wherein each of the plurality of individual task items specifies a particular specific task related to the upstream exploration and production areas of the oil and gas industry, and wherein each of the plurality of individual task items is user-selectable to display a display for the particular specific task specified by the individual task item;
selecting a first individual task item of the plurality of individual task items in response to a second user input; and
displaying the first display in response to said selecting the first individual task item;
wherein the first display comprises one task item, wherein the task item is the first individual task item, and wherein the task item is the currently active task item.

13. The method of claim 1, wherein the first display comprises a plurality of task items, wherein the tasks specified by the plurality of task items are high-level tasks, wherein each of the plurality of task items is user-selectable to display information related to the particular high-level task specified by the task item, and wherein one of the plurality of task items is the currently active task item.

14. The method of claim 13, further comprising:
selecting a different one of the plurality of task items in response to a second user input, wherein the selected different one of the plurality of task items becomes the currently active task item in response to said selecting; and
displaying a different one or more subtask items each associated with a second task specified by the currently active task item, wherein each of the different one or more subtask items specifies a particular subtask of the second task, wherein each of the different one or more subtask items is user-selectable to display task details of the particular subtask specified by the subtask item.

15. The method of claim 1, wherein the first display and the plurality of task detail displays are configured to be displayed by user interface software.

16. The method of claim 15, wherein the user interface software implements a web browser, and wherein the first display and the plurality of task detail displays are provided to the web browser by a web server.

17. The method of claim 15, wherein the first display and the plurality of task detail displays are provided to the user interface software by an Application Service Provider (ASP).

18. The method of claim 1, wherein the plurality of task detail displays further comprise information for use in assisting the end users in performing one or more portions of at least one task related to the geology and geophysics disciplines of the upstream exploration and production areas of the oil and gas industry.

19. The method of claim 1, wherein the plurality of task detail displays further comprise information for use in assisting the end users in performing one or more portions of at least one task related to the geology discipline of the upstream exploration and production areas of the oil and gas industry.

20. The method of claim 1, wherein the plurality of task detail displays further comprise information for use in assisting the end users in performing one or more portions of at least one task related to the geophysics discipline of the upstream exploration and production areas of the oil and gas industry.

21. The method of claim 1, wherein the plurality of task detail displays further comprise information for use in assisting the end users in performing one or more portions of at least one task related to the drilling discipline of the upstream exploration and production area of the oil and gas industry.

22. The method of claim 1, wherein the plurality of task detail displays further comprise information for use in assisting the end users in performing one or more portions of at least one task related to the production engineering discipline of the upstream exploration and production area of the oil and gas industry.

23. The method of claim 1, wherein the plurality of task detail displays further comprise information for use in assisting the end users in performing one or more portions of at least one task related to the reservoir engineering discipline of the upstream exploration and production area of the oil and gas industry.

24. The method of claim 1, wherein the plurality of task detail displays further comprise information for use in assisting the end users in performing one or more portions of at least one task related to the business management discipline of the upstream exploration and production area of the oil and gas industry.

25. The method of claim 1, wherein the plurality of task detail displays further comprise information for use in assisting the end users in performing one or more portions of at least one task related to the information management discipline of the upstream exploration and production area of the oil and gas industry.

26. A computer-based method for assisting end users in performing tasks related to the upstream exploration and production areas of the oil and gas industry, the method comprising:
displaying a plurality of individual task items on a first display, wherein each of the plurality of individual task items specifies a particular task related to the upstream exploration and production areas of the oil and gas industry, and wherein each of the plurality of individual task items is user-selectable to display a display for the particular task specified by the individual task item;
selecting a first individual task item of the plurality of individual task items in response to a first user input;
displaying a second display for a first task specified by the first individual task item in response to said selecting the first individual task item, wherein the second display includes one or more subtask items each specifying a particular subtask of the first task, and wherein each of the one or more subtask items is user-selectable to display task details of the particular subtask specified by the subtask item;
selecting a first subtask item of the one or more subtask items associated with the first task in response to a second user input; and
displaying in the second display one or more task detail items of a first subtask specified by the first subtask item in response to said selecting the first subtask item, wherein each of the one or more task detail items are user-selectable to display one of a plurality of task detail displays associated with the particular task detail item;
wherein the plurality of task detail displays each comprises information for use in assisting the end users in performing one or more portions of at least one of the tasks related to the upstream exploration and production areas of the oil and gas industry.

27. The method of claim 26, wherein the information comprised in one or more of the plurality of task detail displays includes information about one or more of products or services for use in the upstream exploration and production areas of the oil and gas industry.

28. The method of claim 26, wherein each of the plurality of task detail displays is associated with one or more of a plurality of task detail items, wherein each of the plurality of task detail items is associated with one of a plurality of subtask items, and wherein each of the plurality of subtask items is associated with one of the plurality of individual task items.

29. The method of claim 26, further comprising:
selecting a first task detail item of the one or more task detail items in response to a third user input; and
displaying a first task detail display in response to said selecting the first task detail item, wherein the first task detail display comprises information about one or more products or services provided by a vendor, and wherein the information is related to performing one or more particular tasks in the upstream exploration and production areas of the oil and gas industry.

30. The method of claim 29, wherein the first task detail display comprises textual information configured for use in finding a solution to a particular problem related to the upstream exploration and production areas of the oil and gas industry.

31. The method of claim 29, wherein the first task detail display comprises one or more icons which are each user-selectable to display additional information configured for use in finding a solution to a particular problem related to the upstream exploration and production areas of the oil and gas industry.

32. The method of claim 31, wherein the additional information includes one or more of textual information, graphical information, video information and audio information.

33. The method of claim 29, wherein the first task detail display comprises one or more items which are user-selectable to display other task detail displays.

34. The method of claim 29, wherein the first task detail display comprises one or more items which are user-selectable to display another portion of the first task detail display.

35. The method of claim 26, wherein the first display, the second display and the plurality of task detail displays are web pages provided by a web server and displayed by a web browser.

36. The method of claim 26, wherein the method is further applicable for assisting the end users in performing tasks related to one or more of the geology, geophysics, drilling, production engineering, reservoir engineering, business management and information management disciplines of the upstream exploration and production areas of the oil and gas industry.

37. A computer-based method for assisting end users in performing high-level tasks related to the upstream exploration and production areas of the oil and gas industry, the method comprising:
displaying a plurality of high-level task items on a first display, wherein each of the plurality of high-level task items specifies a high-level task related to the upstream exploration and production areas of the oil and gas industry, and wherein each of the plurality of high-level task items is user-selectable to display more information related to the particular high-level task specified by the high-level task item;
selecting a first high-level task item of the plurality of high-level task items in response to a first user input;
displaying one or more task topic items associated with a high-level task specified by the first high-level task item in response to selecting the first high-level task item, wherein each of the one or more task topic items specifies a particular task topic of the high-level task, wherein each of the one or more task topic items is user-selectable to display task details of the particular task topic specified by the task topic item;
selecting a first task topic item of the one or more task topic items associated with the first high-level task in response to a second user input; and
displaying in the second display one or more task detail items in response to said selecting the first task topic item, wherein each of the one or more task detail items are user-selectable to display one of a plurality of task detail displays associated with the particular task detail item;
wherein the plurality of task detail displays each comprises information for use in assisting the end users in performing one or more portions of at least one of the high-level tasks related to the upstream exploration and production areas of the oil and gas industry.

38. The method of claim 37, wherein the information comprised in one or more of the plurality of task detail displays includes information about one or more of products or services for use in the upstream exploration and production areas of the oil and gas industry.

39. The method of claim 37, wherein each of the plurality of task detail displays is associated with one or more of a plurality of task detail items, wherein each of the plurality of task detail items is associated with one of a plurality of subtask items, and wherein each of the plurality of subtask items is associated with one of the plurality of individual task items.

40. The method of claim 37, farther comprising:
selecting a first task detail item of the one or more task detail items in response to a third user input; and
displaying a first task detail display in response to said selecting the first task detail item, wherein the first task detail display comprises information about one or more products or services provided by a vendor, and wherein the information is related to performing one or more particular tasks in the upstream exploration and production areas of the oil and gas industry.

41. The method of claim 40, wherein the first task detail display comprises textual information configured for use in finding a solution to a particular problem related to the upstream exploration and production areas of the oil and gas industry.

42. The method of claim 40, wherein the first task detail display comprises one or more icons which are each user-selectable to display additional information configured for use in finding a solution to a particular problem related to the upstream exploration and production areas of the oil and gas industry.

43. The method of claim 42, wherein the additional information includes one or more of textual information, graphical information, video information and audio information.

44. The method of claim 40, wherein the first task detail display comprises one or more items which are user-selectable to display other task detail displays.

45. The method of claim 40, wherein the first task detail display comprises one or more items which are user-selectable to display another portion of the first task detail display not currently displayed.

46. The method of claim 37, wherein the first display, the second display and the plurality of task detail displays are web pages provided by a web server and displayed by a web browser.

47. The method of claim 37, wherein the method is further applicable for assisting the end users in performing tasks related to one or more of the geology, geophysics, drilling, production engineering, reservoir engineering, business management and information management disciplines of the upstream exploration and production areas of the oil and gas industry.

48. A computer-based method for assisting end users in performing tasks related to a field of endeavor, the method comprising:
accessing a first display, the first display comprising:
one or more task items, wherein each of the one or more task items specifies a particular task related to the field of endeavor; and
one or more subtask items each associated with a first task specified by a currently active task item of the one or more task items, wherein each of the one or more subtask items specifies a particular subtask of the first task, wherein each of the one or more subtask items is user-selectable to display task details of the particular subtask specified by the subtask item;
selecting a first subtask item of the one or more subtask items associated with the first task in response to a first user input; and
displaying one or more task detail items of a first subtask specified by the first subtask item in response to said selecting the first subtask item, wherein each of the one or more task detail items are user-selectable to display one of a plurality of task detail displays associated with the particular task detail item;
wherein the plurality of task detail displays each comprises information for use in assisting the end users in performing one or more portions of at least one of the tasks related to the field of endeavor.

49. The method of claim 48, wherein the field of endeavor is the oil and gas industry.

50. The method of claim 49, wherein the field of endeavor is the upstream exploration and production areas of the oil and gas industry.

51. The method of claim 50, wherein the field of endeavor is the geology and geophysics discipline of the upstream exploration and production areas of the oil and gas industry.

52. A server computer system comprising:
a processor; and
a memory, wherein the memory includes:
a knowledge base, wherein the knowledge base comprises information on a plurality of tasks related to the upstream exploration and production areas of the oil and gas industry;
a server program; and
a plurality of displays, wherein the plurality of displays are configured to be provided by the server program as a task-centric user interface to the knowledge base;
wherein the server program is executable by the processor within the server computer system to:
provide a first display of the plurality of displays to a client system, wherein the first display comprises one or more task items each associated with one of the plurality of tasks;
receive a first user input specifying a first of the one or more task items and selecting a first of the one or more tasks associated with the first task item;
provide a second display of the plurality of displays to the client system in response to the first user input, wherein the second display comprises one or more subtask items each associated with one of one or more subtasks of the first task;
receive a second user input specifying a first of the one or more subtask items and selecting a first of the one or more subtasks associated with the first subtask item; and
update the second display on the client system in response to the second user input, wherein after the update the second display comprises one or more task detail items each associated with one of one or more task details of the first subtask;
wherein each of the one or more task detail items are user-selectable to display one of a plurality of task detail displays associated with the particular task detail item; and
wherein the plurality of task detail displays each comprises information for use in assisting end users in performing one or more portions of at least one of the tasks related to the upstream exploration and production areas of the oil and gas industry.

53. The server computer system of claim 52, wherein the server program is further executable by the processor within the server computer system to:
receive a third user input selecting a first task detail item of the one or more task detail items; and
provide a first task detail display to the client system in response to the third user input, wherein the first task detail display comprises information about one or more products or services provided by a vendor, and wherein the information is related to performing one or more particular tasks related to the upstream exploration and production areas of the oil and gas industry.

54. The server computer system of claim 53, wherein the first task detail display comprises textual information configured for use in finding a solution to a particular problem related to the upstream exploration and production areas of the oil and gas industry.

55. The server computer system of claim 54, wherein the textual information comprises one or more items associated with other task detail displays, and wherein the server program is further executable by the processor within the server computer system to:
receive a fourth user input selecting a first of the one or more items; and
provide a second task detail display to the client system in response to the fourth user input selecting the first item.

56. The server computer system of claim 54, wherein the first task detail display comprises one or more icons which are each user-selectable to display additional information configured for use in finding a solution to a particular problem related to the upstream exploration and production areas of the oil and gas industry, wherein the additional information includes one or more of textual information, graphical information, video information and audio information, and wherein the server program is further executable by the processor within the server computer system to:
receive a fourth user input selecting a first of the one or more icons; and
provide a display to the client system in response to the fourth user input, wherein the display displays particular additional information associated with the first icon.

57. The server computer system of claim 52, wherein the server program is a web server program, and wherein the plurality of displays are web pages configured to be displayed by a web browser.

58. The server computer system of claim 52, wherein the server program is accessed from the client system through an Application Service Provider (ASP).

59. The server computer system of claim 52, wherein the knowledge base comprises information on a plurality of tasks related to one or more of the geology, geophysics, drilling, production engineering, reservoir engineering, business management and information management disciplines of the upstream exploration and production areas of the oil and gas industry.

60. A server computer system comprising:
a processor; and
a memory, wherein the memory includes:
a knowledge base, wherein the knowledge base comprises information on a plurality of tasks related to the upstream exploration and production areas of the oil and gas industry;
a server program; and
a plurality of displays, wherein the plurality of displays are configured to be provided by the server program as a task-centric user interface to the knowledge base;
wherein the server program is executable by the processor within the server computer system to:
provide a first display of the plurality of displays to a client system, wherein the first display comprises a plurality of task items each associated with one of the plurality of tasks;
receive a first user input specifying a first of the plurality task items and selecting a first of the plurality of tasks associated with the first task item;
update the first display on the client system in response to the first user input specifying the first task item, wherein after the update the first display comprises one or more subtask items each associated with one of one or more subtasks of the first task;
receive a second user input specifying a first of the one or more subtask items and selecting a first of the one or more subtasks associated with the first subtask item; and
update the first display on the client system in response to the second user input specifying the first subtask item, wherein after the update the first display comprises one or more task detail items each associated with one of one or more task details of the first subtask;
wherein each of the one or more task detail items are user-selectable to display one of a plurality of task detail displays associated with the particular task detail item; and
wherein the plurality of task detail displays each comprises information for use in assisting end users in performing one or more portions of at least one of the tasks related to the upstream exploration and production areas of the oil and gas industry.

61. The server computer system of claim 60, wherein the server program is further executable by the processor within the server computer system to:
receive a third user input selecting a first task detail item of the one or more task detail items; and
provide a first task detail display to the client system in response to the third user input, wherein the first task detail display comprises information about one or more products or services provided by a vendor, and wherein the information is related to performing one or more particular tasks in the upstream exploration and production areas of the oil and gas industry.

62. The server computer system of claim 61, wherein the first task detail display comprises textual information configured for use in finding a solution to a particular problem related to the upstream exploration and production areas of the oil and gas industry.

63. The server computer system of claim 62, wherein the textual information comprises one or more items associated with other task detail displays, and wherein the server program is further executable by the processor within the server computer system to:
receive a fourth user input selecting a first of the one or more items; and
provide a second task detail display to the client system in response to the fourth user input selecting the first item.

64. The server computer system of claim 61, wherein the first task detail display comprises one or more icons which are each user-selectable to display additional information configured for use in finding a solution to a particular problem related to the exploration and production areas of the oil and gas industry, wherein the additional information includes one or more of textual information, graphical information, video information and audio information, and wherein the server program is further executable by the processor within the server computer system to:
receive a fourth user input selecting a first of the one or more icons; and
provide a display to the client system in response to the fourth user input, wherein the display displays particular additional information associated with the first icon.

65. The server computer system of claim 60, wherein the server program is a web server program, and wherein the plurality of displays are web pages configured to be displayed by a web browser.

66. The server computer system of claim 60, wherein the server program is accessed from the client system through an Application Service Provider (ASP).

67. The server computer system of claim 60, wherein the knowledge base comprises information on a plurality of tasks related to one or more of the geology, geophysics, drilling, production engineering, reservoir engineering, business management and information management disciplines of the upstream exploration and production areas of the oil and gas industry.

68. A system for assisting end users in performing tasks related to the upstream exploration and production areas of the oil and gas industry through a task-centric online environment, the system comprising:
a server computer system comprising a first processor and a first memory, wherein the first memory includes:
a knowledge base, wherein the knowledge base comprises information on a plurality of tasks related to the upstream exploration and production areas of the oil and gas industry;
a server program; and
a plurality of displays, wherein the plurality of displays are configured to be provided by the server program as a task-centric user interface to the knowledge base;
a client computer system comprising a display device, a second processor and a second memory;
wherein the system is operable to:
display on the display device of the client system a first display of the plurality of displays, wherein the first display is provided to the client system by the server system, and wherein the first display comprises:
one or more task items, wherein each of the one or more task items specifies a particular task related to the upstream exploration and production areas of the oil and gas industry; and
one or more subtask items each associated with a first task specified by a currently active task item of the one or more task items, wherein each of the one or more subtask items specifies a particular subtask of the first task, wherein each of the one or more subtask items is user-selectable to display task details of the particular subtask specified by the subtask item;
receive a first user input on the client system selecting a first subtask item of the one or more subtask items associated with the first task; and
update the first display displayed on the client system to display one or more task detail items of a first subtask specified by the first subtask item in response to the first user input selecting the first subtask item, wherein each of the one or more task detail items is associated with one of the plurality of displays, and wherein each of the one or more task detail items are user-selectable to display one of the plurality of displays associated with the particular task detail item;
wherein each of the displays associated with the one or more task detail items comprises information for use in assisting the end users in performing one or more portions of at least one of the tasks related to the upstream exploration and production areas of the oil and gas industry.

69. The system of claim 68, wherein the server program is a web server program, wherein the second memory includes a web browser executable within the client computer system to display web pages on the display device of the client system, and wherein the plurality of displays are web pages configured to be displayed by the program instructions.

70. The system of claim 68, wherein the system is further operable to:
receive a second user input on the client system selecting a first task detail item of the one or more task detail items; and
display on the client system a first task detail display in response to the second user input selecting the first task detail item, wherein the first task detail display comprises information about one or more products or services provided by a vendor, and wherein the information is related to performing one or more particular tasks in the upstream exploration and production areas of the oil and gas industry.

71. The system of claim 70, wherein the first task detail display comprises textual information configured for use in finding a solution to a particular problem related to the upstream exploration and production areas of the oil and gas industry, wherein the textual information comprises one or more items which are user-selectable to display other task detail displays.

72. The system of claim 70, wherein the first task detail display comprises one or more icons which are each user-selectable to display additional information configured for use in finding a solution to a particular problem related to the upstream exploration and production areas of the oil and gas industry, wherein the additional information includes one or more of textual information, graphical information, video information and audio information.

73. The system of claim 68, wherein the tasks are specific tasks, and wherein the system is further operable to, prior to said accessing the first display:
display on the client system a second display comprising a plurality of individual task items, wherein each of the plurality of individual task items specifies a particular specific task related to the upstream exploration and production areas of the oil and gas industry, and wherein each of the plurality of individual task items is user-selectable to display a display for the particular specific task specified by the individual task item;
receive a second user input selecting a first individual task item of the plurality of individual task items;
wherein the first display is displayed on the client system in response to the second user input selecting the first individual task item; and
wherein the first display comprises one task item, wherein the task item is the first individual task item, and wherein the task item is the currently active task item.

74. The system of claim 68, wherein the first display comprises a plurality of task items, wherein the tasks specified by the plurality of task items are high-level tasks, wherein each of the plurality of task items is user-selectable to display information related to the particular high-level task specified by the task item, and wherein one of the plurality of task items is the currently active task item, and wherein the system is further operable to:
receive a second user input selecting a different one of the plurality of task items, wherein the selected different one of the plurality of task items becomes the currently active task item in response to said selecting; and
update the first display displayed on the client system to display a different one or more subtask items each associated with a second task specified by the currently active task item in response to the second user input, wherein each of the different one or more subtask items specifies a particular subtask of the second task, wherein each of the different one or more subtask items is user-selectable to display task details of the particular subtask specified by the subtask item.

75. The system of claim 68, wherein each of the displays associated with the one or more task detail items further comprises information for use in assisting the end users in performing one or more portions of at least one task related to the geology and geophysics disciplines of the upstream exploration and production areas of the oil and gas industry.

76. The system of claim 68, wherein each of the displays associated with the one or more task detail items further comprises information for use in assisting the end users in performing one or more portions of at least one task related to the geology discipline of the upstream exploration and production areas of the oil and gas industry.

77. The system of claim 68, wherein each of the displays associated with the one or more task detail items further comprises information for use in assisting the end users in performing one or more portions of at least one task related to the geophysics discipline of the upstream exploration and production areas of the oil and gas industry.

78. The system of claim 68, wherein each of the displays associated with the one or more task detail items further comprises information for use in assisting the end users in performing one or more portions of at least one task related to the drilling discipline of the upstream exploration and production area of the oil and gas industry.

79. The system of claim 68, wherein each of the displays associated with the one or more task detail items further comprises information for use in assisting the end users in performing one or more portions of at least one task related to the production engineering discipline of the upstream exploration and production area of the oil and gas industry.

80. The system of claim 68, wherein each of the displays associated with the one or more task detail items further comprises information for use in assisting the end users in performing one or more portions of at least one task related to the reservoir engineering discipline of the upstream exploration and production area of the oil and gas industry.

81. The system of claim 68, wherein each of the displays associated with the one or more task detail items further comprises information for use in assisting the end users in performing one or more portions of at least one task related to the business management discipline of the upstream exploration and production area of the oil and gas industry.

82. The system of claim 68, wherein each of the displays associated with the one or more task detail items further comprises information for use in assisting the end users in performing one or more portions of at least one task related to the information management discipline of the upstream exploration and production area of the oil and gas industry.

83. A carrier medium comprising program instructions, wherein the program instructions are computer-executable to implement:
accessing a first display comprising:
one or more task items, wherein each of the one or more task items specifies a particular task related to the upstream exploration and production areas of the oil and gas industry; and
one or more subtask items each associated with a first task specified by a currently active task item of the one or more task items, wherein each of the one or more subtask items specifies a particular subtask of the first task, wherein each of the one or more subtask items is user-selectable to display task details of the particular subtask specified by the subtask item;
selecting a first subtask item of the one or more subtask items associated with the first task in response to a first user input; and
displaying one or more task detail items of a first subtask specified by the first subtask item in response to said selecting the first subtask item, wherein each of the one or more task detail items are user-selectable to display one of a plurality of task detail displays associated with the particular task detail item;
wherein the plurality of task detail displays comprise information for use in assisting end users in performing tasks related to the upstream exploration and production areas of the oil and gas industry.

84. The carrier medium of claim 83, wherein the program instructions are further computer-executable to implement:
selecting a first task detail item of the one or more task detail items in response to a second user input; and
displaying a first task detail display in response to said selecting the first task detail item, wherein the first task detail display comprises information about one or more products or services provided by a vendor, and wherein the information is related to performing one or more particular tasks in the upstream exploration and production areas of the oil and gas industry.

85. The carrier medium of claim 83, wherein the tasks are specific tasks, and wherein the program instructions are further computer-executable to implement, prior to said accessing the first display:
accessing a second display comprising a plurality of individual task items, wherein each of the plurality of individual task items specifies a particular specific task related to the upstream exploration and production areas of the oil and gas industry, and wherein each of the plurality of individual task items is user-selectable to display a display for the particular specific task specified by the individual task item;
selecting a first individual task item of the plurality of individual task items in response to a second user input; and
displaying the first display in response to said selecting the first individual task item;
wherein the first display comprises one task item, wherein the task item is the first individual task item, and wherein the task item is the currently active task item.

86. The carrier medium of claim 83, wherein the first display comprises a plurality of task items, wherein the tasks specified by the plurality of task items are high-level tasks, wherein each of the plurality of task items is user-selectable to display information related to the particular high-level task specified by the task item, and wherein one of the plurality of task items is the currently active task item, and wherein the program instructions are further computer-executable to implement:
selecting a different one of the plurality of task items in response to a second user input, wherein the selected different one of the plurality of task items becomes the currently active task item in response to said selecting; and
displaying a different one or more subtask items each associated with a second task specified by the currently active task item, wherein each of the different one or more subtask items specifies a particular subtask of the second task, wherein each of the different one or more subtask items is user-selectable to display task details of the particular subtask specified by the subtask item.

87. The carrier medium of claim 83, wherein the first display and the plurality of task detail displays are web pages provided by a web server and displayed by a web browser.

88. The carrier medium of claim 83, wherein the plurality of task detail displays further comprise information for use in assisting end users in performing tasks related to one or more of the geology, geophysics, drilling, production engineering, reservoir engineering, business management and information management disciplines of the upstream exploration and production area of the oil and gas industry.
